(19) United States
(12) Patent Application Publication
(10) Pub. No.: US 2013/0026047 A1
(43) Pub. Date: Jan. 31, 2013

(54) METHOD AND APPARATUS FOR ELECTROLYTIC SURFACE ROUGHENING TREATMENT AND METHOD AND APPARATUS FOR MANUFACTURING PLANOGRAPHIC PRINTING PLATE PRECURSOR

(71) Applicants: Hiroshi KOMATSU, Haibara-gun (JP); Hisashi HOTTA, Haibara-gun (JP)

(72) Inventors: Hiroshi KOMATSU, Haibara-gun (JP); Hisashi HOTTA, Haibara-gun (JP)

(73) Assignee: FUJIFILM CORPORATION, Tokyo (JP)

(21) Appl. No.: 13/560,498

(22) Filed: Jul. 27, 2012

(30) Foreign Application Priority Data
Jul. 29, 2011 (JP) 2011-167274
Feb. 7, 2012 (JP) 2012-024196

(51) Int. Cl. B41N 3/00; C25F 3/02

(52) U.S. Cl. 205/659; 204/242

(57) ABSTRACT

An aluminum support is manufactured at lower cost by efficiently performing a surface roughening treatment with dispersed pits formed on the aluminum support. In an electrolytic surface roughening treatment method for performing an electrolytic surface roughening treatment on a strip-shaped metal as being conveyed in an acidic electrolytic solution by applying an alternating waveform voltage, the method includes a step of applying a negative voltage to the metal plate at least once while the alternating waveform voltage is being applied so that the metal plate assumes a negative polarity.

### BACKGROUND OF THE INVENTION

1. Field of the Invention

The present invention relates to a method and apparatus for an electrolytic surface roughening (etching) treatment and a method and apparatus for manufacturing a planographic printing plate precursor and, in particular, to a method and apparatus for an electrolytic surface roughening treatment and a method and apparatus for manufacturing a planographic printing plate precursor, in which an electrolytic surface roughening treatment is performed on a strip-shaped metal plate as being conveyed in an acidic electrolyte solution by applying an alternating waveform current.

2. Description of the Related Art

Conventionally, when a photosenstive composite is provided on pure aluminum or its alloy (hereinafter collectively referred to as “aluminum”) and on aluminum having an anodic oxide coating generated thereon for the purpose of coloring, dyeing, painting, or a planographic printing plate, the surface of the aluminum support is generally roughened (etched) as a method for increasing adhesion to an aluminum support.

This roughening (etching) of the surface of the aluminum support is performed by electrolyzing the aluminum support, and this process is called an electrolytic surface roughening treatment.

The electrolytic surface roughening treatment is performed by applying an alternating waveform current such as a sinusoidal current, a square wave current, or a trapezoidal wave current, or a direct current to the aluminum support in an acidic electrolytic solution.

The acidic electrolytic solution for use in the electrolytic surface roughening treatment is normally nitric acid, hydrochloric acid, sulfuric acid, phosphoric acid, or a mixture thereof each at a predetermined ratio.

In the electrolytic surface roughening treatment with an alternating current, pits are generated by an anodic reaction, and aluminum hydroxide (hereinafter referred to as a smut) is generated at pit portions by a cathode reaction. If this smut generation amount is insufficient, the resistance at the pit portion is decreased to cause the current to concentrate on the pit portion, thereby decreasing dispersibility of the pits. To increase dispersibility of the pits, it is required to increase current density of the alternating current electrolytic surface roughening treatment, but this poses a problem of increasing cost due to an increase in electric power.

To solve the problem described above, as means for dispersing the pits, Japanese Patent Application Laid-Open No. 10-30200 is disclosed, for example. Japanese Patent Application Laid-Open No. 10-30200 discloses that it is preferable that a ratio between an anode reaction time and a cathode reaction time of the alternating current be 1 to 20, a ratio between an electrical quantity on the anode cycle and an electrical quantity on the cathode cycle be 2 to 20, and the anode reaction time be 5 msec to 1000 msec.

### SUMMARY OF THE INVENTION

However, in Japanese Patent Application Laid-Open No. 10-30200, a chatter mark, which is banded gloss unevenness occurring due to a difference in electrolytic reaction between the anode reaction and the cathode reaction, disadvantageously deteriorates. To prevent this, the electrical quantity on the anode cycle and the electrical quantity on the cathode cycle are required to be set as being low. With this, the time of the electrolytic surface roughening treatment is increased, and therefore the line speed has to be set to be slow. Furthermore, if the electrical quantity on the cathode cycle is large compared with the electrical quantity on the anode cycle, an electrode used as a counter electrode has a large electrical quantity on the anode cycle, thereby disadvantageously accelerating deterioration of the electrode.

The present invention was made in view of these circumstances and aims to achieve efficient roughening of a surface of a strip-shaped metal plate such as an aluminum support while dispersing pits and to provide a method and an apparatus for performing an electrolytic surface roughening treatment at lower cost.

To achieve the object described above, the present invention provides an electrolytic surface roughening treatment method for performing an electrolytic surface roughening treatment on a strip-shaped metal plate being conveyed in an acidic electrolytic solution by applying an alternating waveform voltage, the method including a step of applying a negative voltage to the metal plate at least once while the alternating waveform voltage is being applied so that the metal plate assumes a negative polarity.

Also, the present invention provides an electrolytic surface roughening treatment apparatus which performs an electrolytic surface roughening treatment on a strip-shaped metal plate, the apparatus including: an electrolytic bath which stores an acidic electrolytic solution and into which the strip-shaped metal plate conveyed; a plurality of alternating waveform voltage applying devices which are provided continuously or intermittently in the acidic electrolytic solution and which apply an alternating waveform voltage; and one or more negative voltage applying devices which are provided between the alternating waveform voltage applying devices and which apply a negative voltage to the metal plate so that the metal plate assumes a negative polarity.

According to the present invention, while a strip-shaped metal plate is subjected to electrolytic surface roughening by an alternating waveform voltage, a negative voltage is applied locally to the metal plate to refill a pit part with smuts, thereby dispersing the pits, efficiently performing surface roughening, and performing the electrolytic surface roughening treatment at lower cost.

Note that in the specification, evenness of pits is determined by analyzing a SEM photograph. And, the surface area of aluminum is analyzed by an AFM. Furthermore, the surface shape of aluminum is quantified by a gloss meter (Suga Test Instruments Co., Ltd).

In the present invention, a current density in the step of applying the negative voltage is preferably −30 A/dm² or more and −20 A/dm² or less, and

Note that the current density when the negative voltage is applied is preferably −10 A/dm² or less, and more preferably −20 A/dm² or less. And, the current density is preferably −50 A/dm² or more, and more preferably −30 A/dm² or more.

In the electrolytic surface roughening treatment method, the step of applying the negative voltage is preferably performed six times or more. Similarly, in the electrolytic surface roughening treatment apparatus, the number of said negative voltage applying devices which apply the negative voltage is preferably six or more.

While a negative voltage is locally applied to the metal plate once or more in the present invention, a larger number of applications is preferable and, specifically six times or more is preferable.

In the present invention, the acidic electrolytic solution is preferably an acidic solution of nitric acid, hydrochloric acid, sulfuric acid, phosphoric acid, or a mixture thereof each at a predetermined ratio, and the strip-shaped metal plate is preferably an aluminum plate.

In the present invention, the acidic solution preferably contains 3 ppm or more metal ions having a hydrogen overvoltage of 650 mV or more.

In the present invention, the metal ions having a hydrogen overvoltage of 650 mV or more are preferably any of ions selected from at least zinc ions, tin ions, and lead ions.

Since an aluminum hydroxide coating is formed on the aluminum support at the time of applying a negative voltage, formation of an oxide coating in the subsequent alternating current electrolysis is suppressed. However, at the same time, since the coating is peeled off due to the occurrence of hydrogen, the effect of suppressing formation of an oxide coating in alternating current electrolysis is decreased.

However, if metal ions having a large hydrogen overvoltage are present in the solution, the metal described above or an oxide of the metal described above are segregated on the aluminum support at the time of applying a negative voltage, and therefore the hydrogen overvoltage is increased to suppress the occurrence of hydrogen. With this, the aluminum hydroxide coating is less prone to be peeled off, and an aluminum hydroxide coating is formed.

For this reason, formation of an oxide coating in alternating current electrolysis is suppressed, and pits are dispersed. With this, many pits having a small pit diameter and a uniform pit size can be formed.

In the present invention, the electrolytic surface roughening treatment method preferably further includes a step of applying a negative voltage to the metal plate, before the step of applying the alternating waveform voltage, so that the metal plate assumes a negative polarity. Similarly, the electrolytic surface roughening treatment apparatus preferably further includes a negative voltage applying device which is provided before the alternating waveform voltage applying devices, and which applies a negative voltage to the metal plate so that the metal plate assumes a negative polarity.

Before an alternating current electrolyzing process by applying an alternating waveform voltage is performed, hydroxide ions (OH⁻) are distributed in advance over the surface of the metal plate by applying a negative voltage. With this, even in a place where the alternating current electrolyzing process starts from an anode reaction, the anode reaction can be suppressed with the distribution of the hydroxide ions distributed to the metal surface.

Also, in the present invention, a platinum-group electrode is preferably used in the negative voltage applying devices.

By using a platinum-group electrode as an electrode applying a negative voltage, a surface roughening treatment can be performed at low power with deterioration of the electrode being sufficiently suppressed.

Also, to achieve the object described above, the present invention provides a planographic printing plate precursor manufacturing method in which a planographic printing plate precursor is manufactured by using the electrolytic surface roughening treatment method described above. Also, to achieve the object described above, the present invention provides a planographic printing plate precursor manufacturing apparatus manufacturing a planographic printing plate precursor by performing an electrolytic surface roughening treatment on a support by the electrolytic surface roughening treatment apparatus described above, and forming a plate-making layer in the support.

According to the present invention, pits with a uniform size can be formed and the number of pits can be increased when an alternating current electrolyzing process is continuously performed on a strip-shaped metal plate as being conveyed in an acidic electrolytic solution by applying an alternating waveform voltage, thereby increasing the surface area of the metal plate.

### BRIEF DESCRIPTION OF THE DRAWINGS

FIG. 1 is a sectional view of an example of an electrolytic surface roughening treatment apparatus including a radial-type alternating-current electrolytic bath in a first embodiment;

FIG. 2 is a sectional view of an example of an electrolytic surface roughening treatment apparatus including a flat-type alternating-current electrolytic bath in a second embodiment;

FIG. 3 is an explanatory diagram of an example of a device system for use in an electrolytic surface roughening method according to the present invention;

FIG. 4 is an explanatory diagram of timings for applying a negative voltage in an alternating-current electrolyzing process;

FIG. 5 is a diagram of experiment results in examples; and

FIG. 6 is a diagram of experiment results in the examples.

### DETAILED DESCRIPTION OF THE PREFERRED EMBODIMENTS

Preferred embodiments of the present invention are described below.

[Electrolyzing Method and Electrolyzing Apparatus]

Examples of an acidic solution for use in the present invention can include a nitric acid solution, a hydrochloric acid solution, a sulfuric acid solution, a phosphoric acid solution, and a mixture thereof. An acidic solution for use in an electrolytic surface roughening treatment is no particularly restrictive, but is preferably an aqueous solution mainly containing nitric acid or an aqueous solution mainly containing hydrochloric acid.

Among electrolyzing methods, an example is described below in which the present invention is applied to an alternating current surface roughening treatment with a nitric acid solution.

### First Embodiment

In the present embodiment, an example is described below in which the present invention is applied to a radial-type electrolytic surface roughening treatment apparatus for performing an electrolytic surface roughening treatment on an aluminum web, which is a continuous strip-shaped aluminum plate, by alternating current electrolysis.

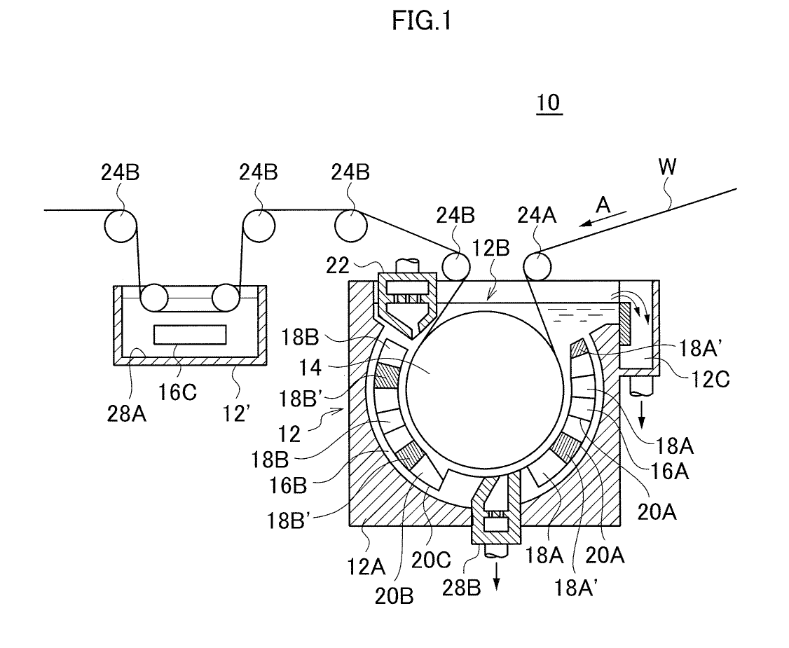

FIG. 1 shows a schematic sectional view of an example of an electrolytic surface roughening treatment apparatus including a radial-type alternating-current electrolytic bath suitably for use in the present invention.

As shown in FIG. 1, an electrolytic surface roughening treatment apparatus 10 includes an electrolytic bath body 12 having provided therein an electrolytic bath 12A where an acidic electrolytic solution is stored, and a feed roller 14 rotatably disposed about an axial line extending in a horizontal direction inside the electrolytic bath 12A and feeding an aluminum web W, which is a strip-shaped continuous thin plate, in a direction indicated by an arrow a, that is, from right to left in FIG. 1.

The electrolytic bath 12A has an inner wall surface formed in a substantially cylindrical shape so as to surround the feed roller 14. On the inner wall surface of the electrolytic bath 12A, electrodes 16A and 16B are provided so as to interpose the feed roller 14. The electrodes 16A and 16B are divided into a plurality of small electrodes 18A and 18B, respectively, along an circumferential direction, and an insulating layer 20A is inserted between the small electrodes 18A and an insulating layer 20B is inserted between the small electrodes 18B. The small electrodes 18A and 18B can be formed by using, for example, graphite, a metal, or the like, and the insulating layers 20A and 20B can be formed by, for example, vinyl chloride resin or the like. The insulating layers 20A and 20B preferably have a thickness of 1 mm to 10 mm. Also, although not shown in FIG. 1, conventionally, the small electrodes 18A and 18B used to be connected to a power supply AC in both the electrodes 16A and 16B.

Note that a negative voltage is applied to small electrodes 18A′ and 18B′ in the present embodiment.

The small electrodes 18A, 18A′, 18B, and 18B′ and the insulating layers 20A and 20B are retained by an insulative electrode holder 20C to form electrodes 16A and 16B.

The power supply AC (not shown) has a function of supplying an alternating waveform current to the small electrodes 18A and 18B. Examples of the power supply AC include, for example, a sinusoidal wave generator circuit which generates a sinusoidal wave by adjusting the current and voltage of a commercial alternating current by using an induced voltage adjustor and a potential transformer, a thyristor circuit which generates a trapezoidal wave current or a square wave current from a direct current obtained by means rectifying the commercial alternating current or the like.

On an upper portion of the electrolytic bath 12A, an opening 12B is provided from which the aluminum wave W, which is an example of a metal plate of the present embodiment and a continuous strip-shaped aluminum plate, is fed and ejected. Near an end of the opening 12B on a downstream side of the electrode 16B, an acidic electrolytic solution refill path 22 is provided for refilling the acidic electrolytic solution to the electrolytic bath 12A. Examples of this acid electrolytic solution include a nitric acid solution, a hydrochloric acid solution, a sulfuric acid solution, a phosphoric acid solution, and a mixture thereof.

Near the opening 12B on the upper portion of the electrolytic bath 12A, a group of upstream guide rollers 24A for guiding the aluminum web W to the inside of the electrolytic bath 12A and downstream guide rollers 24B guiding the aluminum web W having been subjected to an electrolytic surface roughening treatment in the electrolytic bath 12A to the outside of the electrolytic bath 12A.

On an upstream side of the electrolytic bath 12A in the electrolytic bath body 12, an overflow bath 12C is provided. The overflow bath 12C has a function of temporarily storing the acidic electrolytic solution overflowing from the electrolytic bath 12A and keeping the height of the fluid level of the electrolytic bath 12A constant.

On a downstream side of the electrolytic bath 12A in the electrolytic bath body 12, an auxiliary electrolytic bath 12′ is provided. The auxiliary electrolytic bath 12′ has a bottom surface 28A formed in a flat shape. And, the bottom surface 28A is provided with an electrode 16C.

The alternating current frequency is not particularly restrictive, but is preferably 40 Hz to 120 Hz, more preferably 40 Hz to 80 Hz, and further preferably 50 Hz to 60 Hz.

The electrical quantity from the start to the end of the electrolytic surface roughening treatment is preferably 10 C/dm² to 1000 C/dm², more preferably 10 C/dm² to 800 C/dm², and further preferably 40 C/dm² to 500 C/dm², in total when the aluminum web W is anodized.

A current Iap at the peak on an anode cycle side and a current Icp at the peak on a cathode cycle side in alternating current are preferably 10 A/dm² to 100 A/dm², more preferably 20 A/dm² to 80 A/dm², and further preferably 30 A/dm² to 60 A/dm². Also, Icp/Iap is preferably 0.9 to 1.5, and preferably 0.9 to 1.0.

In the electrolytic surface roughening treatment, it is preferable that a cutoff period in which no alternating current flows through the aluminum web W is provided once or more in one or two or more electrolytic baths and that the length of the cutoff time is set to be 0.001 seconds to 0.6 seconds because honeycomb pits are uniformly formed on the entire surface of the aluminum web W.

The operation of the electrolytic surface roughening treatment apparatus 10 in the present embodiment is described below.

The aluminum web W guided from right in FIG. 1 is first fed by the upstream guide rollers 24A to the electrolytic bath 12A.

The aluminum web W fed to electrolytic bath 12A first passes through the small electrode 18A′ at a negative voltage. At this time, with the small electrode 18A′ at the negative voltage, the negative voltage is applied to the aluminum web W, and a cathode reaction occurs at the aluminum web W. With this, hydroxide ions are generated on a surface of the aluminum web W facing a direct current part 26.

The aluminum web W having hydroxide ions generated on its surface passes through the small electrodes 18A′ at the negative voltage, and is then conveyed along the electrode 16A. With an alternating waveform voltage applied to the small electrodes 18A from the power supply AC; an anode or cathode reaction occurs on a surface of the aluminum web W facing the electrode 16A.

Next, in a manner similar to that described above, the aluminum web W is conveyed along the electrode 16B and, with an alternating waveform voltage applied to the electrode 16B from the power supply AC, an anode or cathode reaction occurs on a surface of the aluminum web W facing the electrode 16B, thereby forming honeycomb pits on the entire surface.

In the present invention, a negative voltage is applied to the aluminum web W at least once while an alternating waveform voltage is being applied so that the aluminum web W assumes a negative polarity.

With the small electrodes 18A′ and 18B′ at a negative voltage, the negative voltage is applied locally to the aluminum web W while the electrolytic surface roughening treatment is being performed on the aluminum web W with the alternating waveform voltage to refill a pit part with smuts, thereby dispersing the pits, efficiently performing surface roughening, and performing the electrolytic surface roughening treatment at lower cost.

The current density when a negative voltage is applied is preferably −10 A/dm² or less, more preferably −20 A/dm² or less, and −50 A/dm² or more, and more preferably −30 A/dm².

Also in the present invention, a negative voltage is preferably applied six times or more while the alternating waveform voltage is being applied. While applying a negative voltage locally to the aluminum web W at least once or more is enough in the present invention, a larger number of applications is preferable and, specifically six times or more is preferable.

Next, the aluminum web W is fed by the feed roller 14 from right to left in FIG. 1, and is guided by the downstream guide rollers 24B to the outside of the electrolytic bath 12A.

Then, the aluminum web W guided to the outside of the electrolytic bath 12A is fed into the auxiliary electrolytic bath 12′.

As described above, the electrolytic surface roughening treatment apparatus 10 in the present embodiment also has a feature that the apparatus 10 can be made by reconstructing the conventional electrolytic surface roughening treatment apparatus at low cost because a small number of components are newly added to a conventional electrolytic surface roughening treatment apparatus in order to manufacture the electrolytic surface roughening treatment apparatus 10.

### Second Embodiment

In the second embodiment, an example is described below in which the present invention is applied to a flat-type electrolytic surface roughening treatment apparatus for performing an electrolytic surface roughening treatment on an aluminum web, which is a continuous strip-shaped aluminum plate, by alternating current electrolysis.

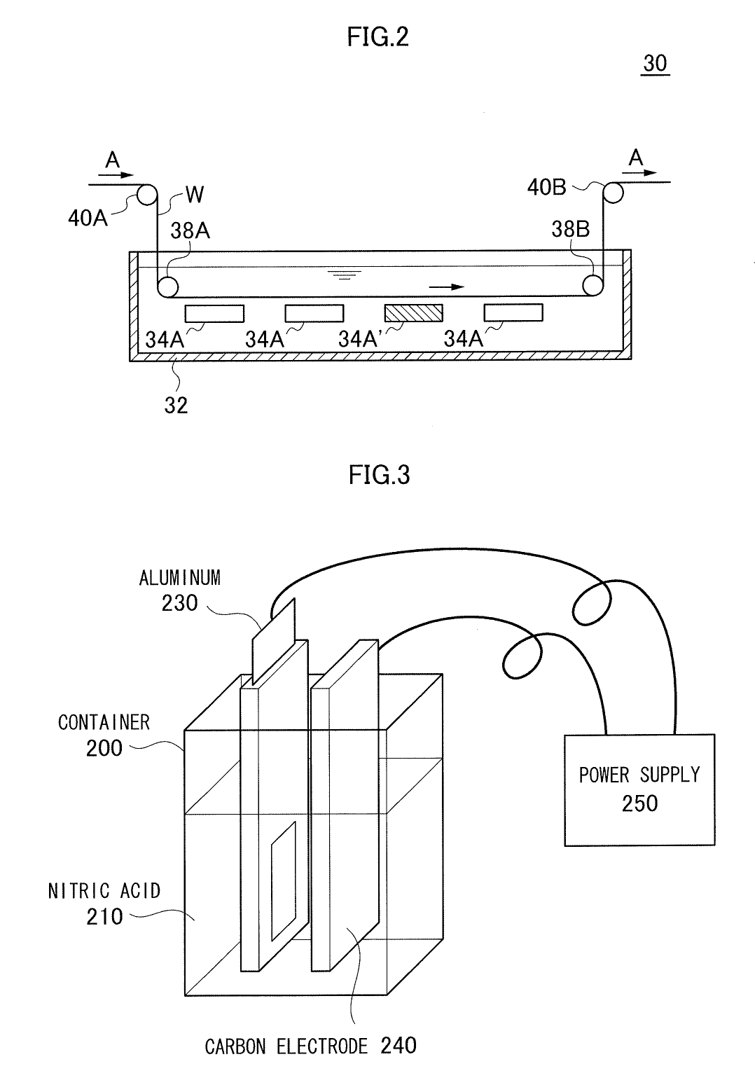

FIG. 2 shows a schematic sectional view of an example of an electrolytic surface roughening treatment apparatus including a flat-type alternating-current electrolytic bath suitably for use in the present invention. The electrolytic surface roughening treatment apparatus 30 is an electrolytic surface roughening treatment apparatus performing an electrolytic surface roughening treatment on an aluminum web W as being conveyed in a substantially horizontal direction by applying an alternating current.

As shown in FIG. 2, the electrolytic surface roughening treatment apparatus 30 mainly includes a box-shaped shallow electrolytic bath 32 extending along a conveying direction A of the aluminum web W and having an open upper surface.

The electrolytic bath 32 mainly includes four plate-shaped electrodes 34A disposed near a bottom surface of the electrolytic bath 32 along the conveying direction A in parallel to a conveyance surface T, which is a conveyance route of the aluminum web W, conveyor rollers 38A and 38B disposed near ends on upstream and downstream sides with respect to the conveying direction A inside the electrolytic bath 32 (hereinafter simply referred to as “upstream and downstream sides”) and conveying the aluminum web W inside the electrolytic bath 32, an feed roller 40A positioned on an upstream side above the electrolytic bath 32 and feeding the aluminum web W to the inside of the electrolytic bath 32, and an ejection roller 40B positioned on an downstream side above the electrolytic bath 32 and ejecting the aluminum web W to the outside of the electrolytic bath 32 passing through the inside of the electrolytic bath 32. Inside the electrolytic bath 32, the acidic aqueous solution described above is stored, and the electrodes 34A and 34A′ are included. An alternating waveform voltage is applied to the electrodes 34A in the electrolytic bath 32. From the electrodes 34A′, a negative voltage is applied to the aluminum web W so that the aluminum web W assumes a negative polarity. Note that application of a negative voltage more effectively works when the negative voltage is applied at a latter half of application period of the alternating waveform voltage. Here, the first half and the latter half are determined according to the half value of the total electrical quantity to be applied the web. The first half means a first half of application period during which an electrical quantity less than ½ of a total electrical quantity is applied, and the latter half means a latter half of application period during which an electrical quantity of ½ or more of the total electrical quantity is applied.

The operation of the electrolytic surface roughening treatment apparatus 30 in the present embodiment is described below.

The aluminum web W is fed by the feed roller 40A to the inside of the electrolytic bath 32, and is then conveyed by the conveyor rollers 38A and 38B along a conveying direction A at a constant speed.

Next, an alternating current is applied from the electrodes 34A to the aluminum web W fed to the electrolytic bath 32. With this, in the aluminum web W, an anode reaction and a cathode reaction alternately occur. When an anode reaction occurs, pits mainly occur. When a cathode reaction occurs, smuts mainly occur at the pit portion. Thus, the surface is roughened.

Next, the aluminum web W is fed to an auxiliary electrolytic bath 42, where a negative voltage is applied from an electrode 44 to the aluminum web W so that the aluminum web W assumes a negative polarity.

With the electrode 44 at a negative voltage, the negative voltage is applied locally to the aluminum web W while the electrolytic surface roughening treatment is being performed on the aluminum web W with the alternating waveform voltage to refill smuts in the pit portion, thereby dispersing the pits, efficiently performing surface roughening, and performing the electrolytic surface roughening treatment at lower cost.

The current density when a negative voltage is applied is preferably −10 A/dm² or less, more preferably −20 A/dm² or less, and −50 A/dm² or more, and more preferably −30 A/dm².

Also in the present invention, a negative voltage is preferably applied six times or more while the alternating waveform voltage is being applied. That is, the apparatus of FIG. 2 preferably includes six or more stages. While applying a negative voltage locally to the aluminum web W at least once or more is enough in the present invention, a larger number of applications is preferable and, specifically six times or more is preferable.

While the electrolytic surface roughening treatment method according to the present invention has been described, the present invention is not restricted to the embodiments described above, and various embodiments can be adopted.

Furthermore, the acidic electrolytic solution is preferably an acidic solution of nitric acid, hydrochloric acid, sulfuric acid, phosphoric acid, or a mixture thereof each at a predetermined ratio in the present invention, and this acidic solution preferably contains 3 ppm or more metal ions having a hydrogen overvoltage of 650 mV or more. Here, the metal ions having a hydrogen overvoltage of 650 mV or more are preferably any of ions selected from at least zinc ions, tin ions, and lead ions.

Since an aluminum hydroxide coating is formed on the aluminum support at the time of applying a negative voltage, formation of an oxide coating to be formed in later alternating current electrolysis is suppressed, but the coating is peeled off at the same time due to the occurrence of hydrogen, and therefore the effect of suppressing formation of an oxide coating in alternating current electrolysis is decreased.

However, if metal ions having a large hydrogen overvoltage are present in the solution, the metal described above or an oxide of the metal described above are segregated on the aluminum support at the time of applying a negative voltage, and therefore the hydrogen overvoltage is increased to suppress the occurrence of hydrogen. With this, the aluminum hydroxide coating is less prone to be peeled off, and an aluminum hydroxide coating is formed.

For this reason, formation of an oxide coating in alternating current electrolysis is suppressed, and pits are dispersed. With this, large number of pits having a small pit diameter and a uniform pit size can be formed.

Note that the pit diameter, the number of pits, and evenness can be determined by analyzing a SEM (Scanning Electron Microprobe) photograph. Also, as for the value of hydrogen overvoltage, “Electrochemistry Handbook, edited by The Electrochemical Society of Japan, Ver. 5, p. 459, Table 13.6” can be referred to.

On the other hand, metals having a hydrogen overvoltage of 600 mV or less have also been studied, but similar effects were not able to be obtained.

Here, the metal ions may be dissolved by adding a metal salt, or metal ions dissolved by using an electrode made of a metal may be used.

Also, while 3 ppm or more metal ions having a hydrogen overvoltage of 650 mV or more are preferable, 10 ppm or more preferable, and 100 ppm or more are further more preferable.

The embodiment in which the acidic solution contains 3 ppm or more metal ions having a hydrogen overvoltage of 650 mV or more can be preferably applied to nitric acid electrolysis and hydrochloric acid electrolysis of an electrolytic surface roughening treatment, which will be described further in detail below. Patterns of a preferable electrolytic surface roughening treatment process to which the present embodiment is applied are as shown in Table 1 below. Note that pattern 1 in Table 1 shows a surface roughening treatment only with nitric acid electrolysis, and pattern 7 shows a surface roughening treatment with mechanical surface roughening, nitric acid electrolysis, and then hydrochloric acid electrolysis to be performed in this order.

TABLE 1

| SURFACE | | | |
|---|---|---|---|
| ROUGHENING | | | |
| TREATMENT | | | HYDROCHLORIC |
| PROCESS | MECHANICAL | NITRIC ACID | ACID |
| SEQUENCE | ROUGHENING | ELECTROLYSIS | ELECTROLYSIS |
| PATTERN 1 | Not Performed | Performed | Not Performed |
| PATTERN 2 | Not Performed | Not Performed | Performed |
| PATTERN 3 | Not Performed | Performed | Performed |
| PATTERN 4 | Performed | Performed | Not Performed |
| PATTERN 5 | Performed | Not Performed | Performed |
| PATTERN 6 | Not Performed | Performed | Performed |
| PATTERN 7 | Performed | Performed | Performed |

[Fabrication of Planographic Printing Plate Precursor Support and Planographic Printing Plate Precursor]

As an example of applying the electrolyzing process method and apparatus according to the present invention, a method for manufacturing a planographic printing plate precursor is described next.

<Aluminum Web (Rolled Aluminum)>

An aluminum plate for use as the aluminum web W in the present embodiment is a metal mainly containing aluminum stable in scale. As described above, the aluminum plate includes an aluminum alloy plate, and these are hereinafter collectively referred to as an aluminum plate.

As the aluminum plate, a plastic plate or paper having an aluminum alloy laminated or vapor-deposited thereon can be used. Furthermore, a composite sheet with an aluminum sheet couple onto a polyethylene terephthalate film as described in Examined Japanese Patent Application Publication No. 48-18327 can also be used. Still further, the aluminum plate can contain elements such as Bi and Ni and incidental impurities

As the aluminum plate, any of those made of materials conventionally and publicly known and used can be used as appropriate, such as aluminum plates of JIS (Japanese Industrial Standards) A1050, JIS A1100, JIS A3003, JIS A3004, JIS A 3005, Internationally-Registered Alloy 3103A, or the like.

Also, the aluminum plate may be manufactured by using a method of a continuous casting type or a DC casting type, and an aluminum plate manufactured by omitting process annealing or a soaking process in the DC (Direct Current) casting type can also be used. In final rolling, an aluminum plate with asperities provided by pack rolling, transferring, or the like can also be used. Furthermore, the aluminum plate may be an aluminum web, which is a continuous strip-shaped sheet material or plate material, or may be a leaf-like sheet obtained by cutting to have a size corresponding to a planographic printing plate precursor to be shipped as a product.

The thickness of the aluminum plate is normally on the order of 0.05 mm to 1 mm, and preferably 0.1 mm to 0.5. This thickness can be changed as appropriate according to the size of the printing machine, the size of the printing plate, and the desire of the user.

In the method for manufacturing a planographic printing plate precursor in the present embodiment, various surface processes including an electrolytic surface roughening treatment in the acidic aqueous solution are performed on the aluminum plate described above to obtain a planographic printing plate precursor. This surface processes may further include various processes.

Before the electrolytic surface roughening treatment, an alkali etching process or a desmutting process is preferably performed, and the alkali etching process and then the desmut process are preferably performed in this order. Furthermore, after the electrolytic surface roughening treatment, the alkali etching process or the desmut process is preferably performed, and the alkali etching process and then the desmut process are preferably performed in this order. Still further, the alkali etching process after the electrolytic surface roughening treatment can be omitted. In the present invention, a mechanical surface roughening treatment is also preferably performed before these processes. Still further, the electrolytic surface roughening treatment may be performed twice or more. Still further, thereafter, anodic oxidation process, a hole sealing process, a hydrophilizing process, or others may also be preferably performed.

In the following, a mechanical surface roughening treatment, a first alkali etching process, a first desmut process, an electrolytic surface roughening treatment, a second alkali etching process, a second desmut process, an anodic oxidation process, a hole sealing process, and a hydrophilizing process are each described in detail. Note that processes to be performed before the electrolytic surface roughening treatment may be referred to with an ordinal number “first” and processes to be performed after the electrolytic surface roughening treatment may be referred to with an ordinal number “second” in the present embodiment.

<Mechanical Surface Roughening Treatment>

The mechanical surface roughening treatment is preferably performed before the electrolytic surface roughening treatment. The mechanical surface roughening treatment is generally performed by using a roller-like brush having many brush hairs such as synthetic resin hairs made of a synthetic resin such as nylon (registered trademark), propylene, or vinyl chloride resin implanted on a cylindrical body surface and, with a slurry fluid containing an abrasive being sprayed onto the rotating roller-like brush, scrubbing one or both of the surfaces of the aluminum web. In place of the roller-like brush and the slurry fluid, an abrasive roller provided with an abrasive layer on the surface may be used. The brush hairs on the roller-like brush have a length which can be determined as appropriate according to the outer diameter of the roller-like brush and the diameter of the body and is generally 10 mm to 100 mm.

As the abrasive, any known one can be used. For example, abrasives such as pumice stone, silica sand, aluminum hydroxide, alumina powder, volcanic ash, and carborundum, emery, or a mixture thereof can be used. Among these, permice stone and silica sand are preferable. In particular, silica sand is preferable because silica sand is harder and is less prone to breakages compared with permice stone and is therefore excellent in surface roughening efficiency. The abrasive preferably has an average particle diameter of 3 μm to 50 μm, more preferably 6 μm to 45 so as to be excellent in surface roughening efficiency and allow a narrow graining pitch. When permice stone is used as an abrasive, an average particle diameter of 40 μm to 45 μm, is particularly preferable. Also, when silica san is used as an abrasive, an average particle diameter of 20 μm to 25 μm, is particularly preferable. For example, the abrasive is suspended in water for use as an abrasive slurry fluid. The abrasive slurry fluid can contain, in addition to an abrasive, a thickener, a dispersant (for example, a surface-active agent), an antiseptic agent, and others. The average particle diameter is a particle diameter that achieves an cumulative ratio of 50% in a cumulative distribution of a ratio of occupation of abrasive particles having respective particle diameters with respect to the volume of the entire abrasive contained in the abrasive slurry fluid.

Also, in the mechanical surface roughening treatment, prior to brush graining, a degreasing process for removing rolling oil on the surface of the aluminum web may be first performed with, for example, a surface-active agent, an organic solvent, an alkaline aqueous solution, or others.

<First Alkali Etching Process>

In the first alkali etching process, etching is performed by bringing the aluminum web into contact with an alkaline solution. If the mechanical surface roughening treatment has not been performed, the first alkali etching process is performed for the purpose of removing rolling oil, soil, a natural oxidation coating on the surface of the aluminum web (rolling aluminum). If the mechanical surface roughening treatment has been performed, the first alkali etching process is performed for the purpose of dissolving an uneven edge portion generated in the mechanical surface roughening treatment to obtain a smooth wavy surface. Examples of a method of bringing the aluminum web into contact with an alkaline solution include a method of letting the aluminum web pass through a bath containing an alkaline solution, a method of immersing the aluminum web in a bath containing an alkaline solution, and a method of spraying an alkaline solution onto the surface of the aluminum web.

The etching amount is preferably 1 g/m² to 15 g/m² for the surface to be subjected to the electrolytic surface roughening treatment in the next process, and is preferably 0.1 g/m² to 5 g/m² (approximately 10% to 40% of the amount for the surface to be subjected to the electrolytic surface roughening treatment) for the surface not to be subjected to the electrolytic surface roughening treatment.

Examples of alkali for use in an alkaline solution include a caustic alkali and an alkali metal salt. Specifically, examples of the caustic alkali include caustic soda and caustic potassium. Also, examples of the alkali metal salt include alkali metal salts such as metasilicate of soda, silicate of soda, potassium metasilicate, and potassium silicate; alkali metal carbonates such as sodium carbonate and potassium carbonate; alkali metal aluminates such as aluminate of soda and potassium aluminate; alkali metal aldonic salts such as gluconate of soda and potassium gluconate; and alkali metal hydrogen phosphate salts such as dibasic phosphate potassium, tribasic phosphate soda, and tribasic phosphate potassium. Among these, because of a quick etching speed and low cost, a caustic alkali solution and a solution containing both a caustic alkali and an alkali metal aluminate are preferable. In particular, a caustic alkali solution is preferable.

The concentration of the alkaline solution can be determined according to the etching amount, and is preferably 1 percent by mass to 50 percent by mass, and more preferably 10 percent by mass to 35 percent by mass. When aluminum ions are dissolved in the alkaline solution, the concentration of the aluminum ions is preferably 0.01 percent by mass to 1.0 percent by mass, and more preferably 3 percent by mass to 8 percent by mass. The temperature of the alkaline solution is preferably 20 degrees Celsius to 90 degrees Celsius. The process time is preferably 1 second to 120 seconds. Regarding the amount of the etching process, dissolution of 1 g/m² to 15 g/m² is preferable, and 3 g/m² to 12 g/m² is more preferable. The first alkali etching process can be performed by using an etching bath normally used for an aluminum web etching process. As an etching bath, either of a batch type and a continuous type can be used. Also, when the first alkali etching process is performed by spraying the alkaline solution onto the aluminum web, a spraying device can be used.

<First Desmut Process>

The first desmut process is performed by, for example, bringing the aluminum web into contact with an acidic solution such as hydrochloric acid, nitric acid, or sulfuric acid having a concentration of 0.5 percent by mass to 30 percent by mass (containing 0.01 percent by mass to 5 percent by mass aluminum ions). Examples of a method of bringing the aluminum web into contact with the acidic solution include a method of letting the aluminum web pass through a bath containing an acidic solution, a method of immersing the aluminum web in a bath containing an acidic solution, and a method of spraying an acidic solution onto the surface of the aluminum web. In the first desmut process, a waste liquid of an aqueous solution mainly containing nitric acid or an aqueous solution mainly containing hydrochloric acid discharged in the electrolytic surface roughening treatment, which will be described further below, or a waste liquid of an aqueous solution mainly containing sulfuric acid discharged in the anodic oxidation process, which will be described further below, is preferably used as an acidic solution. The liquid temperature in the first desmut process is preferably 25 degrees Celsius to 90 degrees Celsius. Also, the process time of the first desmut process is preferably 1 second to 180 seconds.

<Electrolytic Surface Roughening Treatment>

The acidic aqueous solution for use in the electrolytic surface roughening treatment is not particularly restrictive, but an aqueous solution mainly containing nitric acid and an aqueous solution mainly containing hydrochloric acid are preferable. The aqueous solution mainly containing nitric acid has a nitric acid concentration of preferably 3 g/L to 20 g/L and more preferably 5 g/L to 15 g/L and an aluminum ion concentration of preferably 3 g/L to 15 g/L and more preferably 3 g/L to 7 g/L. The aluminum ion concentration in the aqueous solution mainly containing nitric acid can be adjusted by adding aluminum nitrate in the nitric acid aqueous solution of the nitric acid concentration. The aqueous solution mainly containing hydrochloric acid has a hydrochloric acid concentration of preferably 3 g/L to 15 g/L and more preferably 5 g/L to 10 g/L and an aluminum ion concentration of preferably 3 g/L to 15 g/L and more preferably 3 g/L to 7 g/L. The aluminum ion concentration in the aqueous solution mainly containing hydrochloric acid can be adjusted by adding aluminum chloride in the hydrochloric acid aqueous solution of the hydrochloric acid concentration.

<Second Alkali Etching Process>

In the second alkali etching process, etching is performed by bringing the aluminum web into contact with an alkali solution. The type of alkali, the method of bringing the aluminum web into contact with the alkali solution, and the device for use are similar to those in the first alkali etching process. For the surface subjected to the electrolytic surface roughening treatment, the etching amount is preferably 0.001 g/m² to 5 g/m², more preferably 0.01 g/m² to 3 g/m², and further preferably 0.05 g/m² to 2 g/m².

Examples of the alkali for use as the alkali solution are those similar to those in the first alkali etching process. The concentration of the alkaline solution can be determined according to the etching amount, and is preferably 0.01 percent by mass to 80 percent by mass. The temperature of the alkaline solution is preferably 20 degrees Celsius to 90 degrees Celsius. The process time is preferably 1 second to 60 seconds. In the second desmut process described further below, when an acidic solution containing sulfuric acid of 100 g/L or more and a liquid temperature of 60 degrees or higher is used, the second alkali etching process can be omitted.

<Second Desmut Process>

The second desmut process is performed by, for example, bringing the aluminum web into contact with an acidic solution containing phosphoric acid, hydrochloric acid, nitric acid, or sulfuric acid having a concentration of 0.5 percent by mass to 30 percent by mass (containing 0.01 percent by mass to 5 percent by mass aluminum ions). Examples of a method of bringing the aluminum web into contact with the acidic solution are similar to those in the first desmut process. In the second desmut process, a waste liquid of a sulfuric acid solution discharged in the anodic oxidation process, which will be described further below, is preferably used as an acidic solution. In place of the waste liquid, a sulfuric acid solution having a sulfuric acid concentration of 100 g/L to 600 g/L, an aluminum ion concentration of 1 g/L to 10 g/L, and a liquid temperature of 60 degrees Celsius to 90 degrees Celsius is also preferably used. The liquid temperature in the first desmut process is preferably 25 degrees Celsius to 90 degrees Celsius. Also, the process time of the first desmut process is preferably 1 second to 180 seconds. In the acidic solution for use in the second desmut process, aluminum or aluminum alloy components may be dissolved.

<Anodic Oxidation Process>

The aluminum web processed in the above-described manner is preferably further subjected to an anodic oxidation process. The anodic oxidation process can be performed by a conventional method of this field. Specifically, when a direct current, a pulsating current, or an alternating current is let flow through the aluminum web in an electrolytic solution, which is an aqueous solution or non-aqueous solution of one or two or more of sulfuric acid, phosphoric acid, chromic acid, oxalic acid, sulfamic acid, benzenesulfonic acid and amidosulfonic acid in combination, an anodic oxidation coating can be formed on the surface of the aluminum web.

Among others, a sulfuric acid solution is preferably used as an electrolytic solution. The concentration of sulfuric acid in the electrolytic solution is preferably 10 g/L to 300 g/L (1 percent by mass to 30 percent by mass), and the concentration of aluminum ions is preferably 1 g/L to 25 g/L (0.1 percent by mass to 2.5 percent by mass), more preferably 2 g/L to 10 g/L (0.2 percent by mass to 1 percent by mass). This electrolytic solution can be formulated by adding aluminum to dilute sulfuric acid having a sulfuric acid concentration of 50 g/L to 200 g/L.

When the anodic oxidation process is performed in an electrolytic solution containing sulfuric acid, a direct current or an alternating current may be applied to the aluminum web. When a direct current is applied to the aluminum web, the current density is preferably 1 A/dm² to 60 A/dm² and more preferably 5 A/dm² to 40 A/dm². When the anodic oxidation process is continuously performed, to prevent a so-called “burn” from occurring due to concentration of a current on part of the aluminum web, it is preferable to initially let a current flow at a low current density of 5 A/dm² to 10 A/dm² at the start of the anodic oxidation process and, as the anodic oxidation process proceeds, increase the current density to 30 A/dm² to 50 A/dm² or more. When the anodic oxidation process is continuously performed, it is preferable to use a liquid electric supply scheme of supplying electricity to the aluminum web via an electrolytic solution.

As an electrode for supplying electricity to the aluminum web, an electrode made of lead, iridium oxide, platinum, ferrite, or the like can be used. Among these, an electrode mainly made of iridium oxide and an electrode with a base material having its surface coated with iridium oxide are preferable. As the base material, any of so-called valve metals such as titanium, tantalum, niobium and zirconium is preferably used. Among the valve metals, titanium and niobium are preferable. Since the valve metals have a relatively large electrical resistance, the surface of a core material made of copper may be cladded with a valve metal to form a base material. When the surface of a core material made of copper is cladded with a valve metal, it is difficult to fabricate a base material with a complex shape, and therefore a core material obtained by dividing a base material for each component may be cladded with a valve metal, and then the respective components may be combined to assemble the base material.

Conditions of the anodic oxidation process vary according to the electrolytic solution for use, and therefore cannot be uniformly determined. However, in general, an electrolytic solution concentration of 1 percent by mass to 80 percent by mass, a liquid temperature of 5 degrees Celsius to 70 degrees Celsius, a current density of 1 A/dm² to 60 A/dm², a voltage of 1 V to 100 V, and an electrolyzing time of 10 seconds to 300 seconds are appropriate. In view of printing resistance of the planographic printing plate, the anodic oxidation process is preferably performed so that an anodic oxidation coating amount is 1 g/m² to 5 g/m². Also, the process is preferably performed so that a difference in anodic oxidation coating amount between a center part and a portion near an edge of the aluminum web is 1 g/m² or less.

<Hole Sealing Process>

A hole sealing process of bringing an aluminum alloy plate having an anodic oxidation coating formed thereon into contact with boiling water, hot water, or water vapor to seal small holes micropores formed by the anodic oxidation process is preferably performed.

<Hydrophilizing Process>

After the anodic oxidation process or after the hole sealing process, a hydrophilizing process is preferably performed by using a method of immersing the plate in an aqueous solution of an alkali metal silicate such as silicate of soda or potassium silicate, a method of applying a hydrophilic vinyl polymer or a hydrophilic compound to form a hydrophilic basecoat layer, or the like. An example of the hydrophilic vinyl polymer is a copolymer of a vinyl polymerizable compound containing a sulfonic acid group such as a polyvinyl sulfonic acid or p-styrene sulfonic acid and a normal vinyl polymerizable compound such as (metha)acrylic alkyl ester. Also, an example of the hydrophilic compound for use in this method is a compound having at least one group selected from a group including a —NH₂ group, a —COOH group, and a sulfo group.

[Formation of Intermediate Layer and Photosensitive Layer>

<Intermediate Layer>

A photosensitive layer can be directly provided on a planographic printing plate support subjected to the hydrophilizing process or a planographic printing plate support subjected to the hydrophilizing process and then further an acidic aqueous solution process. As required, an intermediate layer can be provided on each of the support described above, and a photosensitive layer can be provided on that intermediate layer.

(Intermediate Layer of High Polymer Compound Having Acid Radical and Onium Group)

As a high polymer compound for use in forming an intermediate layer, a high polymer compound having an acid radical or having a constituent having an acid radical and also a constituent having an onium group is more suitably used. As the acid radical of the constituent of this high polymer compound, an acid radical having an acid dissociation exponent (pKa) of 7 or less is preferable, more preferably —COOH, —SO₃H, —OSO₃H, —PO₃H₂, —OPO₃H₂, —CONHSO₂, or —SO₂NHSO₂—, particularly preferably —COOH. The constituent having a suitable acid radical is represented by a polymerizable compound represented by the following general formula (1) or general formula (2).

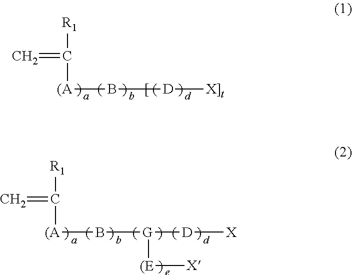

In the formulas, A represents a divalent linking group. B represents an aromatic group or a substituted aromatic group. D and E each independently represent a divalent linking group. G represents a trivalent linking group. X and X′ each independently represent an acid radical having pKa 7 or less or its alkali metal salt or ammonium salt. R1 represents a hydrogen atom, an alkyl group, or a halogen atom. a, b, d, and e each independently represent 0 or 1. t is an integer of 1 to 3. Among the constituents having an acid radical, more preferably, A represents —COO— or CONH—, B represents a phenylene group or a substituted phenylene group, and its substituent is a hydroxyl group, a halogen atom, or an alkyl group. D and E each independently represent an alkylene group or a divalent linking group represented by a molecular formula of CₙH₂ₙO, CₙH₂ₙS, or CₙH₂ₙ₊₁N. G is a trivalent linking group represented by a molecular formula of CₙH₂ₙ₋₁, CₙH₂ₙ₋₁O, CₙH₂ₙ₋₁S, or CₙH₂ₙN. Here, however, n represents an integer of 1 to 12. X and X′ each independently represent carboxylic acid, sulfonic acid, phosphonic acid, sulfuric acid monoester, or phosphoric acid monoester. R1 represents a hydrogen atom or an alkyl group. a, b, d, and e each independently represent 0 or 1, but a and b are not simultaneously 0. Among the constituents having an acid radical, a compound represented by a general formula (1) is particularly preferable, B represents a phenylene group or a substituted phenylene group, and its substituent is a hydroxy group or an alkyl group having a carbon number of 1 to 3. D and E each independently represent an alkylene group having a carbon number of 1 to 2 or an alkylene group having a carbon number of 1 to 2 linked with an oxygen atom. R1 represents a hydrogen atom or a methyl group. X represents a carboxylic acid group. a is 0, and b is 1.

Specific examples of constituents having acid radicals are, although not restricted thereto, acrylic acid, methacryl acid, crotonic acid, isocrotonic acid, itaconic acid, maleic acid, maleic anhydride, and further more as shown below.

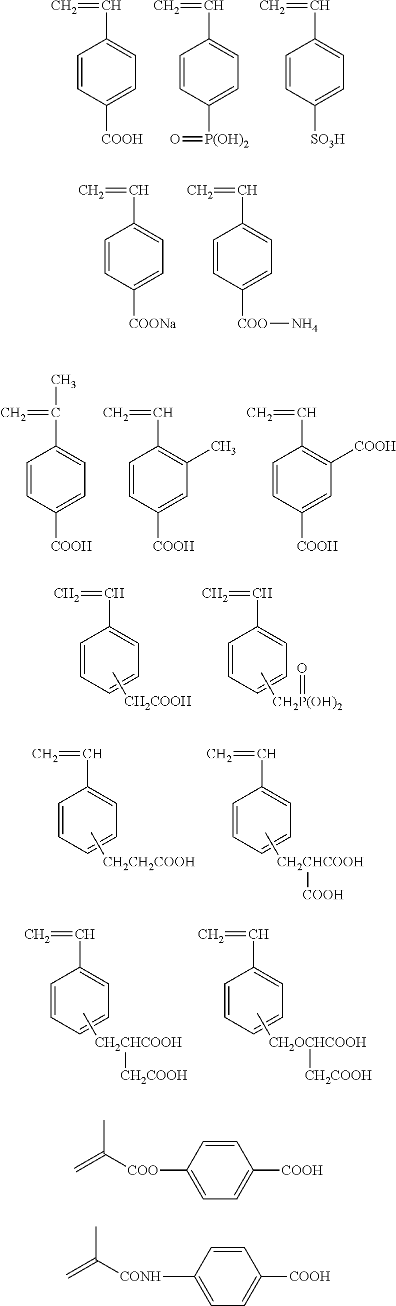

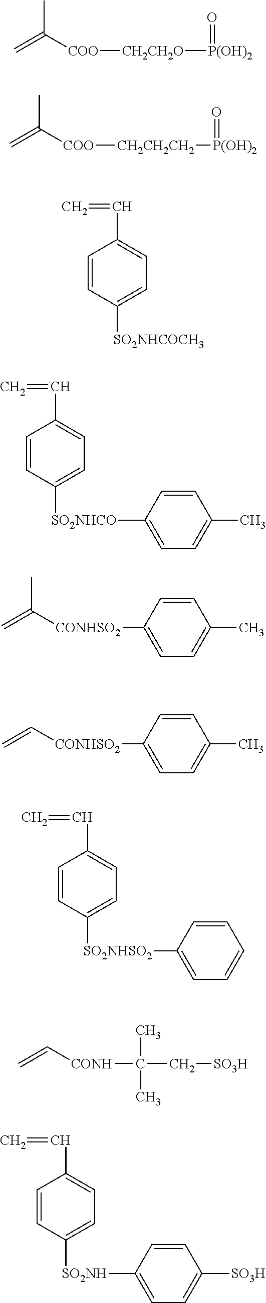

One or two or more types of the constituents having the acidic radicals as shown above may be combined together.

(Intermediate Layer of High Polymer Compound Having Onium Group)

Also, a preferable onium group of the constituents of a high polymer compound for use in formation of the intermediate layer is an onium group formed of a group V or VI atoms in the periodic table, more preferably an onium group formed of a nitrogen atom, a phosphorus atom, or a sulfur atom, and particularly preferably an onium group formed of a nitrogen atom. Also, this high polymer compound is preferably a vinyl-based polymer with its backbone chain structure being an acrylic resin, methacrylic resin, or polystyrene or a polymer such as a urethane resin, polyester, or polyamide. Among these, a vinyl-based polymer with its backbone chain structure being an acrylic resin, methacrylic resin, or polystyrene is further preferable. A particularly preferable high polymer compound is a polymer that is a polymerizable compound with its constituents having an onium group represented by the following general formulas (3), (4), or (5).

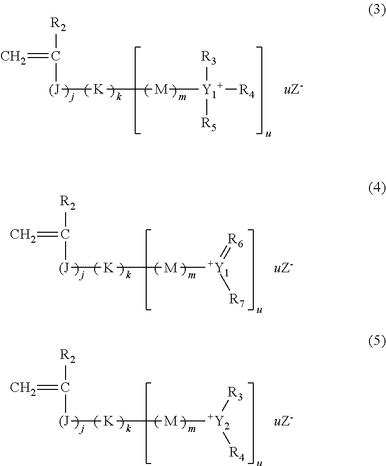

In the formulas, J represents a divalent linking group. K represents an aromatic group or a substituted aromatic group. M represents a divalent linking group. Y1 represents a group V atom in the periodic table, and Y represents a group VI atom in the periodic table. Z— represents a pairing anion. R2 represents a hydrogen atom, an alkyl group, or a halogen atom. R3, R4, R5, and R7 each independently represent a hydrogen atom, or an alkyl group, aromatic group, or aralkyl group that may be coupled with a substituent in some cases. R6 represents an alkylidyne group or a substituted alkylidyne group. R3 and R4, or R6 and R7 may be coupled to each other to form a ring. j, k, and m each independently represent 0 or 1. u represent an integer of 1 to 3. More preferably, among the constituents having an onium group, J represents —COO— or CONH—, K represents a phenylene group or a substituted phenylene group, and its substituent is a hydroxyl group, a halogen atom, or an alkyl group. M represents an alkylene group or a divalent linking group represented by a molecular formula of CₙH₂ₙO, CₙH₂ₙS, or CₙH₂ₙ₊₁N, where n represents an integer of 1 to 12. Y1 represents a nitrogen atom or a phosphorus atom, and Y2 represents an sulfur atom. Z-represents a halogen ion, PF₆—, BF₄—, or R₈SO₃—. R₂ represents a hydrogen atom or an alkyl group. R3, R4, R₅, and R₇ each independently represent a hydrogen atom, or an alkyl group, aromatic group, or aralkyl group that may be coupled with a substituent in some cases and having a carbon number of 1 to 10. R6 represents an alkylidyne group or a substituted alkylidyne group having a carbon number of 1 to 10. R3 and R4, or R6 and R7 may be coupled to each other to form a ring. j, k, and m each independently represent 0 or 1, but a and b are not simultaneously 0. Particularly preferably, among the constituents having an onium group, K represents a phenylene group or a substituted phenylene group, and its substituent is a hydroxy group or an alkyl group having a carbon number of 1 to 3. M represents an alkylene group having a carbon number of 1 to 2 or an alkylene group having a carbon number of 1 to 2 linked with an oxygen atom. Z— represents a chlorine ion or R₈SO₃—. R₂ represents a hydrogen atom or a methyl group. j is 0, and k is 1.

<Photosensitive Layer>

By providing a photosensitive layer on the planographic printing plate support before the intermediate layer is formed or the planographic printing plate support having the intermediate layer formed thereon, a planographic printing plate precursor can be obtained.

The photosensitive layer is not particularly restrictive, and examples of the photosensitive layer include a visible-light-exposure-type plate-making layer and a laser-exposure-type plate-making layer to be exposed to laser light such as infrared laser light. The visible-light-exposure-type plate-making layer and the laser-exposure-type plate-making layer are described below.

(1) Visible-Light-Exposure-Type Plate-Making Layer

The visible-light-exposure-type plate-making layer can be formed of a photosensitive resin and, as required, a composite containing a coloring agent or the like. Examples of the photosensitive resin include a positive-type photosensitive resin that dissolves in a developing agent when exposed to light and a negative-type photosensitive resin that becomes insoluble in the developing agent when exposed to light. An example of the positive-type photosensitive resin is a combination of a diazide compound such as a quinone diazide compound or a naphthoquinone diazide compound and a phenol resin such as a phenol novolac resin or a cresol novolac resin. Examples of the negative-type photosensitive resin include a combination of a diazo compound such as a diazo resin (for example, a condensate of an aromatic diazonium salt and an aldehyde such as formaldehyde), an inorganic salt of the diazo resin, or an organic salt of the diazo resin, and a binder such as a (metha)acrylate resin, a polyamide resin, or a polyurethane resin, and a combination of a vinyl polymer such as a (metha)acrylate resin or a polystyrene resin, a vinyl polymerizable compound such as a (metha)acrylic ester or styrene, and a photopolymerization initiator such as a benzoin derivative, a benzophenone derivative, or a thioxanthone derivative.

As the coloring agent, in addition to a normal colorant, an exposure coloring colorant that colors on exposure, an exposure discoloring colorant that nearly or completely becomes colorless can be used. An example of the exposure coloring colorant is a leuco dye. Examples of the exposure discoloring colorant include a triphenylmethane-based colorant, a diphenylmethane-based colorant, an oxazine-based colorant, a xanthene-based colorant, an iminonaphthoquinone-based colorant, an azomethine-based colorant, and an anthraquinone-based colorant.

The visible-light-exposure-type plate-making layer can be formed by coating a photosensitive resin solution obtained by mixing the photosensitive resin and the coloring agent in a solvent and then drying. An example of a solvent to be used for the photosensitive resin solution is a solvent capable of dissolving the photosensitive resin and having volatility to some extent at room temperature. Specific examples are an alcohol-based solvent, a ketone-based solvent, an ester-based solvent, an ether-based solvent, a glycol-ether-based solvent, an amide-based solvent, and a carbonate-based solvent. Examples of the alcohol-based solvent include ethanol, propanol, and butanol. Examples of the ketone-based solvent include acetone, methyl ethyl ketone, methyl propyl ketone, methyl isopropyl ketone, and diethyl ketone. Examples of the ester-based solvent include ethyl acetate, propyl acetate, methyl formate, and ethyl formate. Examples of the ether-based solvent includes tetrahydrofuran and dioxane. Examples of the glycol-ether-based solvent includes ethyl cellosolve, methyl cellosolve, and butyl cellosolve. Examples of the amide-based solvent include dimethyl formamide and dimethyl acetamide. Examples of the carbonate-based solvent include ethylene carbonate, propylene carbonate, diethyl carbonate, and dibutyl carbonate.

The method of coating the photosensitive resin solution is not particularly restrictive, and a conventionally known method can be used, such as a roll coat method, wire bar coat method, a dip coat method, an air knife coat method, a roll coat method, or a blade coat method.

(2) Laser-Exposure-Type Plate-Making Layer

Main examples of a laser-exposure-type plate making layer include a negative-type laser plate-making layer in which a portion irradiated with laser light is left, a positive-type laser plate-making layer in which a portion irradiated with laser light is removed, and a photopolymerization-type laser plate-making layer in which photopolymerization occurs when the layer is irradiated with laser light.

The negative-type laser plate-making layer can be formed by using a negative-type laser plate-making layer formation fluid in which (A) an acid precursor that decomposes by heat or light to generate acid, (B) an acid-cross-linkage compound that cross-links by the acid generated as the acid precursor decomposes, (C) an alkali soluble resin, (D) an infrared ray absorbing agent, and (E) a phenolic hydroxyl group are dissolved or suspended in an appropriate solvent.

An example of the acid precursor (A) is a compound, such as iminophosphate compound, that decomposes by ultraviolet light, visible light, or heat to generate sulfonic acid. In addition, compounds for use as a photo cation polymerization initiator, a photo radical polymerization initiator, and a photodiscoloring agent can also be used as the acid precursor (A). Examples of the acid-cross-linkage compound (B) include an aromatic compound having at least one of an alkoxymethyl group and a hydroxyl group; a compound having an N-hydroxymethyl group, an N-alkoxymethyl group, or an N-acyloxymethyl group; and an epoxy compound. An example of the alkali soluble resin (C) is a polymer having a hydroxyaryl group at a side chain of a novolac resin, poly(hydrostyrene), or the like.

An example of the infrared absorption agent (D) is a dye or pigment capable of absorbing an infrared ray having a waveform of 760 nm 1200 nm. Specific examples are a black pigment, a red pigment, a metal powder pigment, a phthalocyanine-based pigment, an azo dye absorbing the infrared ray having the waveform described above, an anthraquinone dye, a phthalocyanine dye, and a cyanine colorant. Examples of the phenolic hydroxyl group include an alkyl group or an alkenyl group represented by a general formula of (R1-X)ₙ—Ar—(OH)ₘ (where R1 represents an alkyl group or an alkenyl group having a carbon number of 6 to 32, X represents a single bond, O, S, COO, or CONH, Ar represents an aromatic hydrocarbon group, a cycloaliphatic carbon group, or a heterocyclic group, and n and m each represent a natural number of 1 to 8). An example of the compound is any of alkylphenols such as nonylphenol. As a negative-type laser plate-making plate formation fluid, other than the constituents described above, a plasticizer can be mixed.

The positive-type laser plate-making layer can be formed by using a positive-type laser plate-making layer formation fluid in which (F) an alkali soluble high polymer, (G) an alkali dissolution inhibitor, and (H) an infrared ray absorbing agent are dissolved or suspended in an appropriate solvent. Examples of the alkali soluble high polymer (F) include a phenol-based polymer having a phenolic hydroxyl group such as a phenol resin, a cresol resin, a novolac resin, a pyrogallol resin, a poly (hydroxystyrene); a sulfonamide-group-containing polymer, which is a polymer in which at least part of monomer units has a sulfonamide group; an active-imide-group-containing polymer obtained by single polymerization or copolymerization of a monomer having an active imide group such as N-(p-toluenesulfonyl)(metha)acrylamide.

An example of the alkali dissolution inhibitor (G) is a compound that reacts with the alkali soluble high polymer (F) by heat to decrease alkali solubility of the alkali soluble high polymer (F). Specific examples are a sulfone compound, ammonium salt, sulfonium salt, and an amide compound. A suitable example of a combination of the alkali soluble high polymer (F) and the alkali dissolution inhibitor (G) is a combination of a novolac resin as the alkali soluble high polymer (F) and a cyanine colorant, which is one type of sulfone compound, as the alkali dissolution inhibitor (G). Examples of the infrared ray absorbing agent (H) include a colorant, dye, and pigment having an absorbing region outside an infrared region having a wavelength of 750 nm to 1200 nm and having a light-heat converting function, such as squalirium colorant, pyrylium colorant, carbon black, insoluble azo dye, and anthraquinone-based dye.

The photopolymerization-type laser plate-making layer can be formed by using a photopolymerization-type laser plate-making layer formation fluid containing (I) a vinyl polymerization compound having an ethyleny unsaturated bond at an end of a molecule. As required, in the photopolymerization-type laser plate-making layer formation fluid, (J) a photopolymerization initiator and (K) a intensifier can be mixed. Examples of the vinyl polymerization compound (I) include ethyleny unsaturated carboxylic acid polyvalent ester, which is an ester of an ethyleny unsaturated carboxylic acid such as (metha)acryl acid, itaconic acid, or maleic acid, and aliphatic polyhydric alcohol; methylene bis(metha)acryl amide formed of the ethyleny unsaturated carboxylic acid and polyvalent amine; and ethyleny unsaturated carboxylic polyvalent amide such as xylylene (metha)acrylamide. Other examples of the vinyl polymerization compound (I) include aromatic vinyl compounds such as styrene and α-methylstyrene, and ethyleny unsaturated carboxylic monoester such as (metha)acrylic acid methyl, and (metha)acrylic acid ethyl. An example of the photopolymerization initiator (J) is a photopolymerization initiator normally used for photopolymerization of a vinyl-based monomer. Examples of the intensifier (K) include a titanocene compound, a triazine compound, a benzophenone-based compound, a benzimidazole-based compound, a cyanine colorant, a merocyanine colorant, a xanthene colorant, and a coumarin colorant.

In the negative-type laser plate making layer formation fluid, the positive-type laser plate-making layer, and the photopolymerization-type laser plate-making layer formation fluid, and the methods of forming the negative-type laser plate making layer formation fluid, the positive-type laser plate-making layer, and the photopolymerization-type laser plate-making layer formation fluid described above, the solvent and coating method described in formation of the photosensitive resin solution can be used. Note that when a photopolymerization-type laser plate-making layer is formed, it is preferable to use a silicone compound having a reactive functional group such as a partial-decomposition-type silane compound obtained by partially decomposing the silane compound with water, alcohol, or carboxylic acid to previously process a surface to be roughened of the planographic printing plate support, because adhesion between the support and the photopolymerization-type laser plate-making layer is improved.

<Mat Layer>

On the surface of the photosensitive layer provided in the manner as described above, a mat layer may be provided to shorten a vacuum drawing time when close contact exposure using a vacuum drawing frame and prevent a burning blur. Specific examples include a method of providing a mat layer as described in Japanese Patent Application Laid-Open No. 50-125805, and Examined Japanese Patent Application Publication Nos. 57-6582 and 61-28986, a method of thermal vapor deposition of solid powder as described in Examined Japanese Patent Application Publication No. 62-62337.

<Backcoat Layer>

On the planographic printing plate precursor obtained in the manner as described above, a coating layer formed of an organic high polymer compound may be provided as required on a back surface (a surface on a side not provided with the photosensitive layer) so as to prevent damage on the photosensitive layer if the plates are stacked. As main constituents of the backcoat layer, at least one type of resin selected from the group of a saturated copolymerization polyester resin, phenoxy resin, polyvinyl acetal resin, and vinylidene chloride resin having a glass transition temperature of 20 degrees Celsius is preferably used.

The saturated copolymerized polyester resin is formed of a dicarboxylic acid unit and a diol unit. Examples of the dicarboxylic acid include an aromatic dicarboxylic acid such as phthalic acid, terephthalic acid, isophthalic acid, tetra bromine phthalate, or chlortetra phthalate, and a saturated fat group dicarboxylic acid such as an adipic acid, azelaic acid, succinic acid, oxalic acid, suberic acid, sebacic acid, malonic acid, or 1,4-cyclohexanedicarboxylic acid.

The backcoat layer can further contain, as appropriate, a dye or pigment for coloring, a silane coupling agent to improve adhesion to the support, a diazonium resin made of diazonium salt, an organic phosphonate, an organic phosphate, a cationic polymer, a wax normally used as a slip agent, high fatty acid, high fatty acid amid, a silicone compound made of dimethylsiloxane, denatured dimethylsiloxane, and polyethylene powder.

The backcoat layer has a thickness that is less prone to damage the photosensitive layer even without a slip sheet, preferably 0.01 pm to 8 μm. If the thickness is less than 0.01 μm, it is difficult to prevent abrasion of the photosensitive layer when the planographic printing plate precursors are handled as being stacked. Also, if the thickness exceeds 8 μm, the backcoat layer is swelled by a chemical agent for use on the periphery of the planographic printing plate during printing to change the thickness, thereby possibly changing printing pressure to degrade printing characteristics.

Various methods can be taken as a method of providing the backcoat layer on the back surface of the planographic printing plate precursor. Examples include a method of dissolving constituents for the backcoat layer in an appropriate solvent to form a solution or an emulsified dispersion, coating the plate with the solution or the dispersion, and then drying the coated plate; a method of laminating a layer formed in a film shape onto the planographic printing plate precursor with a bonding agent or by heat; and a method of forming a molten coat by a melt extrusion machine and laminating the molten coat onto the planographic printing plate precursor. The most preferable method for ensuring a suitable thickness is the method of dissolving constituents for the backcoat layer in an appropriate solvent to form a solution, coating the plate with the solution, and then drying the coated plate.

In manufacturing a planographic printing plate precursor, either of the back surface of the backcoat layer and the surface of the photosensitive layer can be provided on the support first, and both may be simultaneously provided.

Thus obtained planographic printing plate precursor is cut to an appropriate size as required, exposed, and then developed for plate making, thereby obtaining a planographic printing plate. In the case of a planographic printing plate precursor having a visible-light-exposure-type plate-making layer (a photosensitive plate-making layer), a transparent film having a printing image formed thereon is superposed on the plate, and the plate is irradiated with visible light for exposure and is then developed, thereby making a planographic printing plate. In the case of a planographic printing plate precursor having a laser-exposure-type plate-making layer, the plate is irradiated with various types of laser light to directly write a printing image for exposure and is then developed, thereby making a planographic printing plate.

While the example has been described in which the present invention is applied to the method of manufacturing a planographic printing plate support, the present invention can be applied to other technical fields for performing an electrolytic surface roughening treatment on the surface of a metal plate.

### EXAMPLES

Next, the present invention is described in further detail below with reference to examples. However, the present invention is not restricted to the examples below.

Description is made with reference to FIG. 3. FIG. 3 is, an explanatory diagram of an example of a device system for use in the electrolytic surface roughening method according to the present invention. In a container 200 with dimensions of 400 mm×300 mm×800 mm, an electrolytic surface roughening method with an alternating current using a nitric acid solution was performed.

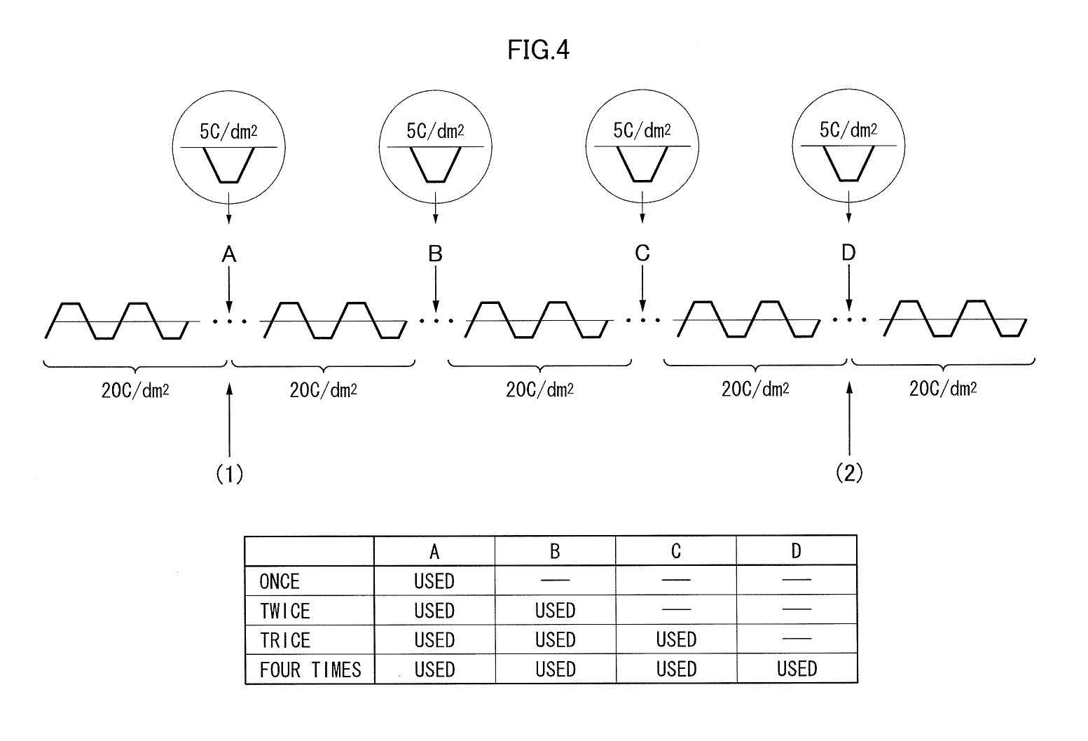

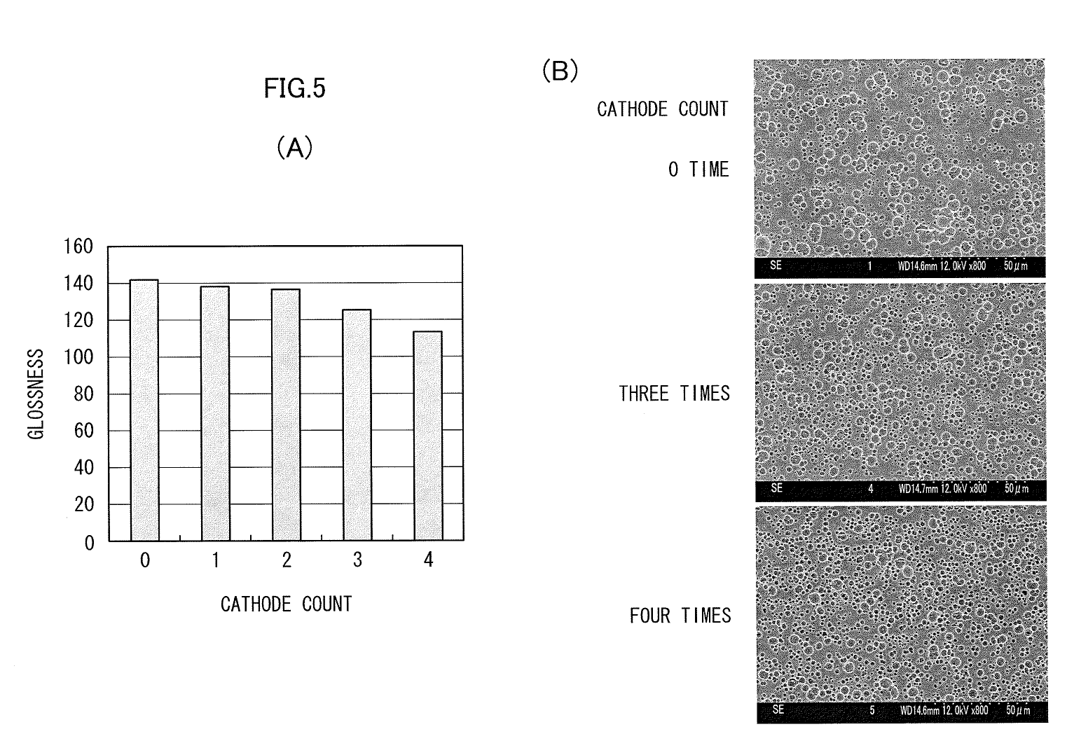

In the device system shown in FIG. 3, an alternating current electrolytic process was performed by setting a concentration of a nitric acid solution 210 of 10 g/l and a liquid temperature of 35 degrees Celsius and using a trapezoidal wave (refer to FIG. 4). A negative voltage was applied to aluminum so that aluminum assumes a negative polarity during the alternating current electrolytic process by using a direct current power supply. The surface shape after the electrolytic process was observed by using a SEM to evaluate and an average pit diameter, pit density, and pit evenness. By using an AFM (Atomic Force Microprobe), the surface area was measured. The glossness of the surface was measured by glossmeter (Suga Test Instruments Co., Ltd).

An aluminum support 230 and a carbon electrode 240 were arranged in the nitric acid solution 210 so that their flat surfaces face each other, and the aluminum support 230 and the carbon 240 were each connected to an alternating current power supply 250. The distance between the aluminum support 230 and the carbon 240 was set at 10 mm. Also, as for the aluminum support 230, A1050 was used as an aluminum material.

(First Experiment)

The aluminum support 230 was subjected to an electrolytic surface roughening treatment with 1% nitric acid solution 210 being stationary. The alternating electrolytic current density was set at 35 A/dm² and the total electrical quantity was set at 100 C/dm². Here, the electrolytic surface roughening treatment was performed with the direct current density being set at 50 A/dm², the electrical quantity being set at 5 C/dm², and the number of times of applying a direct current being varied.

Note that application of a directsurrent was performed as follows: As shown in FIG. 4, the electrical quantity was 20 C/dm² when the number of times of application was one, the electrical quantities were 20 C/dm² and 40 C/dm² when the number of times of application was two, the electrical quantities were 20 C/dm², 40 C/dm², and 60 C/dm² when the number of times of application was three, and the electrical quantities were 20 C/dm², 40 C/dm², 60 C/dm², and 80 C/dm² when the number of times of application was four.

The roughened surface of the aluminum support 230 was shot by using SEM photography. Also the glossness of the surface was measured by a glossmeter (Suga Test Instruments Co., Ltd). The experiment results are shown in FIG. 5.

It can be found that as the number of times of applying a direct current is increased, the glossness of the aluminum support 230 is decreased (portion (A) of FIG. 5), thereby making pits even. Therefore, it can be found that as the number of times of applying a direct current is increased, the pit density is increased, and an aluminum support having better pit evenness can be manufactured (portion (B) of FIG. 5).

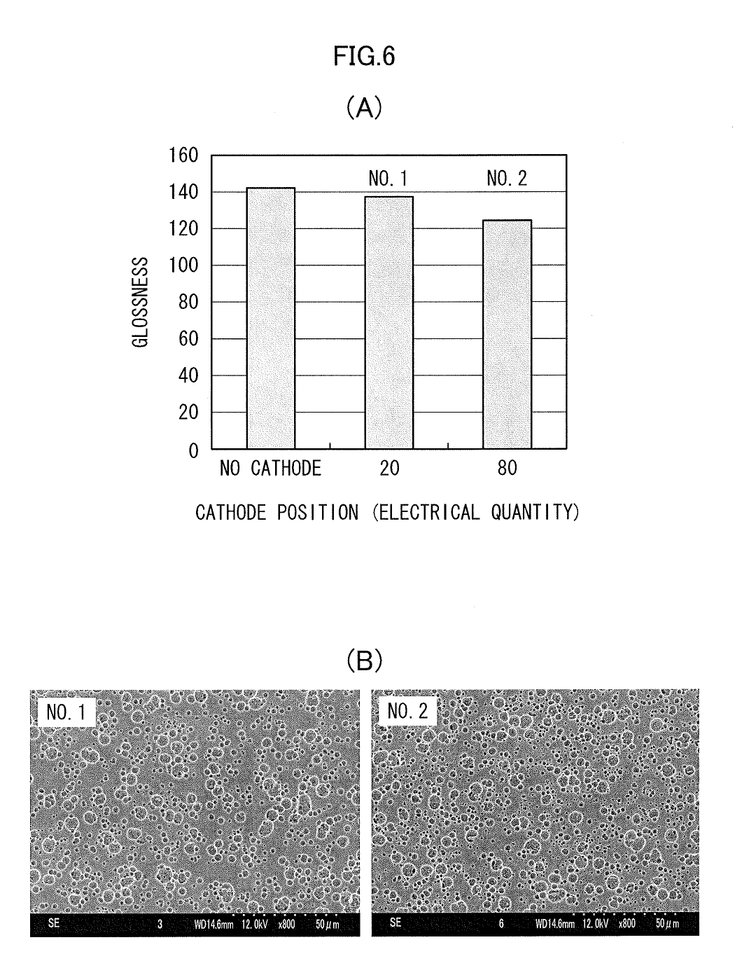

Also, when the number of times of applying a direct current (a negative voltage) was one, measurements were performed with timing of applying a direct current being varied. Regarding glossness of the surface of the aluminum support 230 and SEM photographs, comparison was performed between the case in which a direct current was applied with an electrical quantity of 20 C/dm² ((1) of FIG. 4) and the case in which a direct current was applied with an electrical quantity of 80 C/dm² ((2) of FIG. 4), with a total electrical quantity of the alternating current of 100 C/dm². The experiment results are shown in portions (A) and (B) of FIG. 6.

As can be seen from the experiment results in portions (A) and (B) of FIG. 6, application of a negative voltage is more effective in a latter-half period even during application of an alternating waveform voltage.

(Second Experiment)

The aluminum support 230 was subjected to an electrolytic surface roughening treatment with 1% nitric acid solution 210 being stationary. The alternating electrolytic current density was set at 35 A/dm² and the total electrical quantity was set at 240 C/dm². Here, the electrolytic surface roughening treatment was performed with the direct current density and the number of times of applying a direct current as parameters being changed. When a direct voltage was applied ten times, a negative voltage was applied at different positions in a first-half process and a latter-half process.

That is, the negative voltage position in the first-half case was applied to the cases in which the electrical quantity was set at 10 C/dm², 20 C/dm², 30 C/dm², 40 C/dm², 50 C/dm², 60 C/dm², 70 C/dm², 80 C/dm², 90 C/dm², and 100 C/dm². On the other hand, the negative voltage position in the latter-half case was applied to the cases in which the electrical quantity was set at 130 C/dm², 140 C/dm², 150 C/dm², 160 C/dm², 170 C/dm², 180 C/dm², 190 C/dm², 200 C/dm², 210 C/dm², and 220 C/dm².

The electrical quantity was set at 130 C/dm² when application was made once in the latter-half process, the electrical quantity was set at 130 C/dm² and 140 C/dm² when application was made twice in the latter-half process, the electrical quantity was set at 130 C/dm², 140 C/dm², and 150 C/dm² when application was made three times in the latter-half process, the electrical quantity was set at 130 C/dm², 140 C/dm², 150 C/dm², 160 C/dm², 170 C/dm², and 180 C/dm² when application was made six times in the latter-half process, and the electrical quantity was set at 130 C/dm², 140 C/dm², 150 C/dm², 160 C/dm², 170 C/dm², 180 C/dm², 190 C/dm², 200 C/dm², 210 C/dm², and 220 C/dm² when application was made ten times in the latter-half process

The roughened surface of the aluminum support 230 was shot by using SEM photography. By observing the surface, the average pit diameter, pit density, and pit evenness were evaluated. By using an AFM, a surface area ratio ΔS (an ratio of increase in actual area with respect to a projected area) was measured. The glossness of the surface was measured by a glossmeter (Suga Test Instruments Co., Ltd). The experiment results are shown in Table 2.

TABLE 2

| | NEGATIVE | | | | | | | |
|---|---|---|---|---|---|---|---|---|
| | VOLTAGE | NEGATIVE | CURRENT | | AVERAGE PIT | PIT DENSITY | | |
| | APPLICATION | VOLTAGE | DENSITY | | DIAMETER | (TEN | | |
| | COUNT | POSITION | (A/dm²) | GLOSSNESS | (μm) | THOUSAND/mm²) | PIT EVENNESS | ΔS |
| COMPARATIVE | 0 | — | 0 | 143.8 | 3 | 5.7 | D | 20.2 |
| EXAMPLE 1 | | | | | | | | |
| COMPARATIVE | 1 | LATTER | −25 | 131.7 | 2.7 | 8.4 | C | 22.9 |
| EXAMPLE 2 | | HALF | | | | | | |
| EXAMPLE 1 | 2 | LATTER | −25 | 126.5 | 2.3 | 10 | B | 24.0 |
| | | HALF | | | | | | |
| EXAMPLE 2 | 3 | LATTER | −25 | 123.5 | 2.1 | 12 | B | 24.7 |
| | | HALF | | | | | | |
| EXAMPLE 3 | 6 | LATTER | −25 | 99.7 | 1.8 | 16 | B | 35.1 |
| | | HALF | | | | | | |
| EXAMPLE 4 | 10 | LATTER | −25 | 85.2 | 1.5 | 18.5 | A | 41.2 |
| | | HALF | | | | | | |
| EXAMPLE 5 | 10 | LATTER | −20 | 85.0 | 1.5 | 18.3 | A | 41.5 |
| | | HALF | | | | | | |
| EXAMPLE 6 | 10 | LATTER | −30 | 85.9 | 1.5 | 18.1 | A | 40.3 |
| | | HALF | | | | | | |
| EXAMPLE 7 | 10 | LATTER | −50 | 96.5 | 1.8 | 16 | B | 35.2 |
| | | HALF | | | | | | |
| EXAMPLE 8 | 10 | LATTER | −10 | 97.5 | 1.8 | 16.2 | B | 35.5 |
| | | HALF | | | | | | |
| EXAMPLE 9 | 10 | FIRST | −25 | 121.2 | 2.0 | 13.1 | B-C | 25.3 |
| | | HALF | | | | | | |

The average pit diameter and the pit density were calculated by analyzing a SEM photograph of 174×254 μm. The pit evenness and the evaluation level were evaluated on a scale of four levels as follows with reference to comparative examples. The pit evenness evaluation is performed by visual sensory evaluation of SEM (Scanning Electron Microscope) photograph at a magnification ratio of 500 times power.

A . . . excellent in pit evenness

B . . . good in pit evenness

B-C . . . a little good in pit evenness

C . . . acceptable in pit evenness

D . . . not acceptable in pit evenness

As can be seen from Table 2, the current density of the direct current at the time of the electrolytic surface roughening treatment is preferably −10 A/dm² or less and more preferably −20 A/dm² or less, and preferably −50 A/dm² or more and more preferably −30 A/dm² or more. With this, an aluminum support with a large pit density and a good pit evenness can be manufactured.

Also, a direct current is applied preferably six times or more, and most preferably ten times or more. With this, an aluminum support with a larger pit density and a better pit evenness can be manufactured.

In the present invention, the position where a cathode reaction is inserted is preferable in the latter half of the electrolytic surface roughening process.

[Use as Planographic Printing Plate Support]

(Desmut Process in Acidic Aqueous Solution)

On to the obtained aluminum plate subjected to the surface roughening treatment, an aqueous solution having a sulfuric acid concentration of 170 g/L, an aluminum ion concentration of 5 g/L, and a temperature of 50 degrees Celsius was sprayed from a spray tube for a desmut process for five minutes. As a sulfuric acid aqueous solution, a waste liquid from the anodic oxidation process, which will be described further below, was used.

Then, liquid drainage was performed with a nip roller. After liquid drainage, the anodic oxidation process was performed without performing a washing process.

(Anodic Oxidation Process)

As an electrolytic solution, an electrolytic solution (at a temperature of 50 degrees Celsius) obtained by dissolving aluminum sulfate in a 170 g/L sulfuric aqueous solution to attain an aluminum ion concentration of 5 g/L was used. The anodic oxidation process was performed so that an average current density during an anode reaction of the aluminum plate was 15 A/dm², and a final oxidation coating amount was 2.7 g/m².

Then, liquid drainage was performed with a nip roller. Furthermore, by using a spray tube having a spray chip for spreading a water jet in a fan shape, a washing process was performed for five minutes, and then liquid drainage was further performed with the nip roller.

(Hydrophilizing Process)

The aluminum plate was immersed in 1 percent by mass silicate of soda aqueous solution (at a temperature of 20 degrees Celsius) for approximately ten seconds. A Si amount on the surface of the aluminum plate measured by a fluorescent X-ray analyzing device was 3.5 mg/m². Then, liquid drainage was performed with the nip roller. Furthermore, by using a spray tube having a spray chip for spreading a water jet in a fan shape, a washing process was performed for five seconds, and then liquid drainage was further performed with the nip roller. Still further, air at 90 degrees Celsius was blown for ten seconds for drying, thereby obtaining a planographic printing plate support.

(Fabrication of Planographic Printing Plate Precursor)

Each planographic printing plate support obtained as described above was provided with an image recording layer of a thermal positive type in a manner as described below to obtain a planographic printing plate precursor. Note that, before the image recording layer is provided, a ground coat layer was provided, which will be described further below.

A ground coat fluid having the following composition was applied on the planographic printing plate precursor, and was dried at 80 degrees Celsius for fifteen seconds, thereby obtaining a coating of ground coat layer. The coating amount of the coating after drying was 15 mg/m².

<Composition of Ground Coat Fluid>

| | |
|---|---|
| High Polymer Compound shown below | 0.3 g |
| Methanol | 100 g |
| Water | 1 g |

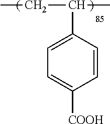

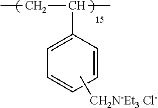

molecular weight of 28,000

Furthermore, a heat-sensitive layer coating fluid having the following composition was prepared, and the planographic printing plate support provided with the ground coat layer was coated with this heat-sensitive layer coating fluid so that the coating amount (the heat-sensitive layer coating amount) is 1.8 g/m², and then the support was dried to form a heat-sensitive layer (an image recording layer of a thermal positive type), thereby obtaining a planographic printing plate precursor.

<Composition of Heat-Sensitive Layer Coating Liquid>

| | |
|---|---|
| Novolac Resin (m-cresol/p-cresol = 60/40, weight-average molecular weight of 7,000, | 0.90 g |
| 0.5 percent by mass unreacted cresol contained) | |
| Ethyl methacrylate/isobutyl methacrylate/methacrylic copolymer (molar ratio of | 0.10 g |
| 35/35/30) | |
| Cyanine dye A represented by the following structural formula | 0.1 g |
| Tetrahydro phthalic anhydride | 0.05 g |
| p-toluenesulfonic acid | 0.002 g |
| 6-hydroxy-β-naphthalenesulfonic acid made of counterions of ethyl violet | 0.02 g |
| Fluorine-based surface active agent (Megafac F-780F, manufactured by DIC | 0.0045 g |
| Corporation, solid contents of 30 percent by mass) | |
| Fluorine-based surface active agent (Megafac F-781F, manufactured by DIC | 0.035 g |
| Corporation, solid contents of 100 percent by mass) | |
| Methyl ethyl ketone | 12 g |

Cyanine dye A

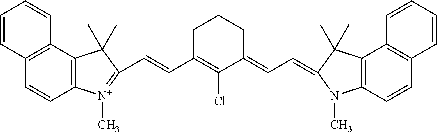 [SMILES: CN1/C(=C\C=C2/CCCC(/C=C/C3=[N+](C)c4ccc5ccccc5c4C3(C)C)=C2Cl)C(C)(C)c2c1ccc1ccccc21]

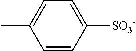

(Evaluations of Planographic printing plate precursor)

Regarding the planographic printing plate precursor, sensitivity of exposure and development and adhesion to an upper layer were evaluated.

(1) Evaluation of Sensitivity of Exposure and Development

By using Trend Setter manufactured by Creo Inc., rendering was performed to form an image on the obtained planographic printing plate precursor at a drum rotating speed of 150 rpm and a beam intensity of 10 W. Then, by using PS processor 940-H, manufactured by FUJIFILM Corporation, filled with an alkali developing agent having the following composition, development was performed for twenty seconds of developing time with the liquid temperature being kept at 30 degrees Celsius, thereby obtaining a planographic printing plate.

As a result, original printing plating plates fabricated based on the conditions of the examples 1 to 3 and comparative examples in Table 2 shown above have a good sensitivity.

The composition of an alkaline developing agent for use in evaluating the sensitivity of exposure and development is as follows.

<Composition of Alkaline Developing Agent>

| | | |
|---|---|---|
| D-sorbit | 2.5 | percent by mass |
| Sodium | 0.85 | percent by mass |
| hydroxide | | |
| Polyethylene glycol lauryl ether | 0.5 | percent by mass |
| (weight-average molecular weight | | |
| of 1,000) | | |
| Water | 96.15 | percent by mass |

(2) Evaluation of Adhesion to Upper Layer (Evaluation of Printing Resistance)

Next, adhesion to an upper layer was evaluated. In evaluation of adhesion to an upper layer, adhesion between the surface of the aluminum support having pits formed thereon and a layer formed on the surface of the aluminum support is evaluated. Here, adhesion to the upper layer was determined by evaluating printing resistance. Printing resistance was performed by evaluating the number of printable sheets under the respective conditions (examples 1 to 3 and comparative examples in Table 1), and is represented as an index when the number of printable sheets in comparative example 1 is taken as 100%.

[Conditions of Printing Resistance Test]

On a Lithrone printing machine manufactured by KOMORI Corporation, the obtained planographic printing plate was subjected to printing by using black ink of DIC-GEOS(N) manufactured by DIC Corporation, and normal printing resistance was evaluated with the number of printing sheets at the time of visually recognizing that the density of a filled-in image starts to become thin.

[Test Result 2-1]

Test results with the aluminum support being stationary are shown in Table 3 (an index for the number of printing-resistive sheets when no direct current is applied is taken as 100%). In this table, samples in the examples and comparative examples were each subjected to an electrolytic surface roughening treatment with the same conditions as those of the examples and comparative examples in Table 2.

TABLE 3

| | | PRINTING |
|---|---|---|
| | ΔS | RESISTANCE |
| COMPARATIVE | 20.2 | 100% |
| EXAMPLE 1 | | |
| COMPARATIVE | 22.9 | 103% |
| EXAMPLE 2 | | |
| EXAMPLE 1 | 24.0 | 105% |
| EXAMPLE 2 | 24.7 | 106% |
| EXAMPLE 3 | 35.1 | 111% |
| EXAMPLE 4 | 41.2 | 118% |
| EXAMPLE 5 | 41.5 | 118% |
| EXAMPLE 6 | 40.3 | 117% |
| EXAMPLE 7 | 35.2 | 111% |
| EXAMPLE 8 | 35.5 | 112% |
| EXAMPLE 9 | 25.3 | 106% |

In particular, as can be seen from the result of example 4, the current density of the direct current at the time of performing an electrolytic surface roughening treatment is preferably −10 A/dm² or less and more preferably −20 A/dm² or less, and preferably −50 A/dm² or more and more preferably −30 A/dm² or more. From this, it can be found that providing smuts by applying a negative voltage during surface roughening contributes to evenness of pits, that is, printing resistance.

As shown in Table 3, printing resistance is improved in all examples 1 to 6 more than the comparative examples. The reason for the improvement in printing resistance can be thought such that, by applying a negative voltage to the aluminum support so that the aluminum support assumes a negative polarity in the course of alternating current electrolyzation, pit evenness is improved to increase the surface area, thereby increasing adhesion to the upper layer.

[Test Result 2-2]

In a flat-type device system (refer to FIG. 2), the line speed was set at 60 m/minute, and a trapezoidal waveform (refer to FIG. 4) was used to perform an alternating-current continuous electrolyzing process on the aluminum support. The concentration of the nitric acid solution was set at 10 g/l and the liquid temperature is set at 35 degrees Celsius. As for the aluminum support 230, A1050 is used as an aluminum material. The alternating-current electrolytic current density was set to 35 A/dm², and the total electrical quantity was set at 100 C/dm². During alternating-current electrolyzation, a direct current power supply was used to apply a negative voltage to aluminum so that aluminum assumes a negative polarity in the course of the alternating-current electrolyzing process. Here, the direct current density was set at 25 A/dm², and the electrical quantity was set at 5 C/dm². Note that the number of times of applying a direct current was four, and the direct current was applied when the alternating-current electrolyzation electric quantity was set at 20 C/dm², 40 C/dm², 60 C/dm², and 80 C/dm². The anodic oxidation process and the hydrophilizing process used after the continuous process on the aluminum support were those of a batch type. Then, as with the first example, a heat-sensitive layer was provided to obtain a planographic printing plate precursor. Note that, before the heat-sensitive layer was provided, a ground coat layer was provided similarly as described above. For the obtained planographic printing plate precursor, sensitivity of exposure and development and adhesion to an upper layer were evaluated. The conditions of a printing resistance test were set so as to be similar to those described above. The results are shown in Table 4 (a tenth example). An index for the number of printing-resistive sheets when no direct current is applied is taken as 100% (a third comparative example). The evaluation of chatter mark is performed by visual observation of a surface state of examples. The evaluation results are classified into four levels as follows.

A . . . no streaks are observed

B . . . slight streaks are observed when the view point is inclined

C . . . clear streaks are observed when the view point is inclined

D . . . clear streaks are observed regardless of inclination of the view point

TABLE 4

| | PRINTING | CHATTER |
|---|---|---|
| | RESISTANCE | MARK |
| COMPARATIVE | 100% | B |
| EXAMPLE 3 | | |
| EXAMPLE 10 | 118% | C |

As shown in Table 4, printing resistance was improved more than comparative example 3. The reason for the improvement in printing resistance can be thought such that, by applying a direct current in the course of alternating-current electrolyzation, pit evenness is improved to increase the surface area, thereby increasing adhesion to the upper layer. It can also be found that a chatter mark can be mitigated by applying the direct current in the course of alternating-current electrolyzation. With this, it has been confirmed that when a continuous alternating-current electrolyzing process is performed with an alternating waveform current while the aluminum web W is being conveyed in the acidic electrolytic fluid, pits having an even size can be formed, and an aluminum support with improved printing resistance can be manufactured.

On the other hand, it can be found that printing resistance is decreased in comparative example 3 with no application of a direct current.

(Third Experiment)

The aluminum support was subjected to an electrolytic surface roughening treatment with 1% nitric acid solution 210 at a liquid temperature of 35 degrees Celsius being stationary. The alternating electrolytic current density was set at 35 A/dm² and the total electrical quantity was set at 240 C/dm². Here, the direct current density was set at 25 A/dm², and the electrical quantity was set at 5 C/dm². The positions where a charge was applied were similar to the positions in the second experiment.

Here, an additive metal in Table 5 shown further below was added each at a density described in the table to 1% nitric acid solution at a liquid temperature of 35 degrees Celsius.

Note that a solution containing zinc ions was obtained by adding zinc nitrate (6-hydrate), a solution containing copper ions was obtained by adding copper nitrate (3-hydrate), a solution containing lead ions was obtained by adding lead nitrate, and a solution containing tin ions was obtained by adding tin nitrate (II).

The roughened surface of the aluminum support was shot by using SEM photography. The glossness of the surface was measured by a glossmeter (Suga Test Instruments Co., Ltd).

The roughened surface of the aluminum support 230 was shot by using SEM photography. By observing the surface, the average pit diameter, pit density, and pit evenness were evaluated. By using an AFM, a surface area ratio ΔS (an ratio of increase in actual area with respect to a projected area) was measured. The glossness of the surface was measured by glossmeter (Suga Test Instruments Co., Ltd). The evaluation results are shown in Table 5. Note that the following examples 1 and 2, and comparative examples 1 to 3 are the same as those of the second experiment described above.

TABLE 5

| | | | HYDROGEN | ADDITIVE METAL ION | |
|---|---|---|---|---|---|
| | NEGATIVE VOLTAGE | ADDITIVE METAL | OVERVOLTAGE (mV) | CONCENTRATION | NEGATIVE VOLTAGE |
| | APPLICATION COUNT | ION TYPE | (LITERATURE DATA) | (ppm) | POSITION |
| COMPARATIVE | 0 | — | — | — | — |
| EXAMPLE 1 | | | | | |
| EXAMPLE 1 | 1 | — | — | — | LATTER |
| | | | | | HALF |
| EXAMPLE 3 | 6 | — | — | — | LATTER |
| | | | | | HALF |
| EXAMPLE 11 | 1 | Zn | 720 | 4 | LATTER |
| | | | | | HALF |
| EXAMPLE 12 | 1 | Zn | 720 | 13 | LATTER |
| | | | | | HALF |
| EXAMPLE 13 | 1 | Zn | 720 | 112 | LATTER |
| | | | | | HALF |
| EXAMPLE 14 | 6 | Zn | 720 | 4 | LATTER |
| | | | | | HALF |
| EXAMPLE 15 | 6 | Zn | 720 | 13 | LATTER |
| | | | | | HALF |
| EXAMPLE 16 | 6 | Zn | 720 | 112 | LATTER |
| | | | | | HALF |
| EXAMPLE 17 | 6 | Cu | 600 | 110 | LATTER |
| | | | | | HALF |
| EXAMPLE 18 | 6 | Pb | 670 | 115 | LATTER |
| | | | | | HALF |
| EXAMPLE 19 | 6 | Sn | 850 | 113 | LATTER |
| | | | | | HALF |

| | | | | PIT DENSITY | | |
|---|---|---|---|---|---|---|
| | CURRENT DENSITY | | AVERAGE PIT | (TEN | | |
| | (A/dm²) | GLOSSNESS | DIAMETER (μm) | THOUSAND/mm²) | PIT EVENNESS | ΔS |
| COMPARATIVE | 0 | 143.8 | 3 | 5.7 | D | 20.2 |
| EXAMPLE 1 | | | | | | |
| EXAMPLE 1 | −25 | 131.7 | 2.7 | 8.4 | C | 22.9 |
| EXAMPLE 3 | −25 | 99.7 | 1.8 | 16 | B | 35.1 |
| EXAMPLE 11 | −25 | 125.5 | 2.6 | 9.1 | C | 24.0 |
| EXAMPLE 12 | −25 | 114.2 | 2.2 | 12.6 | B-C | 29.6 |
| EXAMPLE 13 | −25 | 108.3 | 2.0 | 13.8 | B-C | 32.0 |
| EXAMPLE 14 | −25 | 99.1 | 1.8 | 16.8 | B | 36.3 |
| EXAMPLE 15 | −25 | 93.1 | 1.5 | 17.1 | A | 37.5 |
| EXAMPLE 16 | −25 | 92.8 | 1.5 | 17.5 | A | 38.1 |
| EXAMPLE 17 | −25 | 98.6 | 1.8 | 16.5 | B | 36.1 |
| EXAMPLE 18 | −25 | 93.9 | 1.6 | 17.1 | A | 37.6 |
| EXAMPLE 19 | −25 | 92.2 | 1.5 | 17.9 | A | 40.1 |

As can be seen from Table 5, the electrolytic surface roughening treatment is preferably performed with an acidic solution containing 3 ppm or more metal ions having a hydrogen overvoltage of 650 mV or more. From this, an aluminum support with a large pit density and good pit evenness can be manufactured.

[Use as Planographic Printing Plate Support]

Exactly the same processes as those of the second experiment were performed (refer to the description of (Desmut Process in Acidic Aqueous Solution), (Anodic Oxidation Process), (Hydrophilizing Process), (Fabrication of Planographic printing plate precursor), and (Evaluations of Planographic printing plate precursor) in [Use as Planographic Printing Plate Support], and the description in [Conditions of Printing Resistance Test]).

[Test Result 3-1]

Test results with the aluminum support being stationary are shown in Table 6 (an index for the number of printing-resistive sheets when no direct current is applied is taken as 100%). In this table, samples in the examples and comparative examples were each subjected to an electrolytic surface roughening treatment with the same conditions as those of the examples and comparative examples in Table 5.

TABLE 6

| | | PRINTING |
|---|---|---|
| | ΔS | RESISTANCE |
| COMPARATIVE | 20.2 | 100% |
| EXAMPLE 1 | | |
| EXAMPLE 1 | 22.9 | 103% |
| EXAMPLE 3 | 35.1 | 116% |
| EXAMPLE 13 | 32.0 | 111% |
| EXAMPLE 16 | 38.1 | 124% |

As can be seen from Table 6, it can be found that an acidic solution containing 3 ppm or more metal ions having a hydrogen overvoltage of 650 mV or more contributes to printing resistance.

[Test Result 3-2]

In a flat-type device system (refer to FIG. 2), the line speed was set at 60 m/minute, and a trapezoidal waveform (refer to FIG. 4) was used to perform an alternating-current continuous electrolyzing process on the aluminum support. The concentration of the nitric acid solution was set at 10 g/l and the liquid temperature is set at 35 degrees Celsius. As for the aluminum support 230, A1050 is used as an aluminum material. The alternating-current electrolytic current density was set to 35 A/dm², and the total electrical quantity was set at 100 C/dm². During alternating-current electrolyzation, a direct current power supply was used to apply a negative voltage to aluminum so that aluminum assumes a negative polarity in the course of the alternating-current electrolyzing process. Here, the direct current density was set at 25 A/dm², and the electrical quantity was set at 5 C/dm². The anodic oxidation process and the hydrophilizing process used after the continuous process on the aluminum support were those of a batch type. Then, a heat-sensitive layer was provided to obtain a planographic printing plate precursor. Note that before the heat-sensitive layer was provided, a ground coat layer was provided similarly as described above. For the obtained planographic printing plate precursor, sensitivity of exposure and development and adhesion to an upper layer were evaluated. The conditions of a printing resistance test were set so as to be similar to those described above. The results are shown in Table 7 (examples 19 and 20). An index for the number of printing-resistive sheets when no direct current is applied is taken as 100% (comparative example 3).

TABLE 7

| | DIRECT CURRENT | METAL | | | | | |
|---|---|---|---|---|---|---|---|
| | APPLICATION | ION | METAL ION | CURRENT | PIT | PRINTING | CHATTER |
| | COUNT | TYPE | CONCENTRATION | DENSITY | EVENNESS | RESISTANCE | MARK |
| COMPARATIVE | 0 | — | — | 0 | D | 100% | C |
| EXAMPLE 3 | | | | | | | |
| EXAMPLE 20 | 1 | Zn | 110 | −25 | B-C | 108% | B-C |
| EXAMPLE 21 | 6 | Zn | 110 | −25 | A | 121% | A |

As shown in Table 7, it was found that printing resistance is improved even when the solution contains metal ions.

What is claimed is:

1. An electrolytic surface roughening treatment method for performing an electrolytic surface roughening treatment on a strip-shaped metal plate being conveyed in an acidic electrolytic solution by applying an alternating waveform voltage, the method comprising
a step of applying a negative voltage to the metal plate at least once while the alternating waveform voltage is being applied so that the metal plate assumes a negative polarity.

2. The electrolytic surface roughening treatment method according to claim 1, wherein
in the step of applying the negative voltage, a current density is −30 A/dm² or more and −20 A/dm² or less.

3. The electrolytic surface roughening treatment method according to claim 1, wherein
the step of applying the negative voltage is performed six times or more.

4. The electrolytic surface roughening treatment method according to claim 1, wherein
the acidic electrolytic solution is an acidic solution of nitric acid, hydrochloric acid, sulfuric acid, phosphoric acid, or a mixture thereof each at a predetermined ratio.

5. The electrolytic surface roughening treatment method according to claim 4, wherein
the acidic solution contains 3 ppm or more metal ions having a hydrogen overvoltage of 650 mV or more.

6. The electrolytic surface roughening treatment method according to claim 5, wherein
the metal ions having a hydrogen overvoltage of 650 mV or more are at least any one of ions selected from zinc ions, tin ions, and lead ions.

7. The electrolytic surface roughening treatment method according to claim 1, further comprising
a step of applying a negative voltage to the metal plate, before the step of applying the alternating waveform voltage, so that the metal plate assumes a negative polarity.

8. The electrolytic surface roughening treatment method according to claim 1, wherein
the strip-shaped metal plate is an aluminum plate.

9. A planographic printing plate precursor manufacturing method in which a planographic printing plate precursor is manufactured by using the electrolytic surface roughening treatment method according to claim 8.

10. An electrolytic surface roughening treatment apparatus which performs an electrolytic surface roughening treatment on a strip-shaped metal plate, the apparatus comprising:
an electrolytic bath which stores an acidic electrolytic solution and into which the strip-shaped metal plate conveyed;
a plurality of alternating waveform voltage applying devices which are provided continuously or intermittently in the acidic electrolytic solution and which apply an alternating waveform voltage; and
one or more negative voltage applying devices which are provided between the alternating waveform voltage applying devices and which apply a negative voltage to the metal plate so that the metal plate assumes a negative polarity.

11. The electrolytic surface roughening treatment apparatus according to claim 10, wherein
a number of said negative voltage applying devices is six or more.

12. The electrolytic surface roughening treatment apparatus according to claim 10, further comprising
a negative voltage applying device which is provided before the alternating waveform voltage applying devices, and which applies a negative voltage to the metal plate so that the metal plate assumes a negative polarity.

13. The electrolytic surface roughening treatment apparatus according to claim 10, wherein
a platinum-group electrode is used in the negative voltage applying device.

14. A planographic printing plate precursor manufacturing apparatus which manufactures a planographic printing plate precursor by performing an electrolytic surface roughening treatment on a support by the electrolytic surface roughening treatment apparatus according to claim 10, and forming a plate-making layer in the support.
